(19) United States
(12) Patent Application Publication
(10) Pub. No.: US 2024/0073865 A1
(43) Pub. Date: Feb. 29, 2024

(54) ENHANCED INTER-UE COORDINATION

(71) Applicant: QUALCOMM Incorporated, San Diego, CA (US)

(72) Inventors: Jung Ho RYU, Fort Lee, NJ (US); Sony AKKARAKARAN, Poway, CA (US); Junyi LI, Fairless Hills, PA (US); Jelena DAMNJANOVIC, Del Mar, CA (US); Hua WANG, Basking Ridge, NJ (US); Tao LUO, San Diego, CA (US)

(21) Appl. No.: 17/820,157

(22) Filed: Aug. 16, 2022

(51) Int. Cl. H04W 72/02; H04W 24/08; H04W 28/26; H04W 72/04; H04W 72/10

(52) U.S. Cl. CPC H04W 72/02; H04W 24/08; H04W 28/26; H04W 72/0406; H04W 72/10

(57) ABSTRACT

Method and apparatus for enhanced inter-UE coordination. The apparatus transmits, to a second UE, an IUC request for an IUC message indicating preferred resources or non-preferred resources for transmission of a signal by a third UE. The apparatus receives, from the second UE, the IUC message indicating the preferred resources or the non-preferred resources for the transmission of the signal by the third UE. The apparatus may select transmission resources for the third UE based at least on the IUC message from the second UE indicating the preferred resources or the non-preferred resources for transmission by the third UE.

### BACKGROUND

### Technical Field

The present disclosure relates generally to communication systems, and more particularly, to sidelink communication.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of wireless communication may comprise direct communication between devices based on sidelink. There exists a need for further improvements in sidelink technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. The apparatus may be a device at a first UE. The device may be a processor and/or a modem at a first UE or the first UE itself. The apparatus transmits, to a second UE, an inter-UE coordination (IUC) request for an IUC message indicating preferred resources or non-preferred resources for transmission of a signal by a third UE. The apparatus receives, from the second UE, the IUC message indicating the preferred resources or the non-preferred resources for the transmission of the signal by the third UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with aspects of the present disclosure.

FIG. 2 illustrates example aspects of a sidelink slot structure, in accordance with aspects of the present disclosure.

FIG. 3 is a diagram illustrating an example of a first device and a second device involved in wireless communication based, e.g., on sidelink, in accordance with aspects of the present disclosure.

FIGS. 4A and 4B illustrate examples of resource reservation for sidelink communication, in accordance with aspects of the present disclosure.

FIG. 5 is an example time diagram for sidelink resource selection, in accordance with aspects of the present disclosure.

FIG. 6 illustrates an example of inter-UE coordination for sidelink communication, in accordance with aspects of the present disclosure.

FIG. 7 is a diagram illustrating an example of preferred and non-preferred resources, in accordance with aspects of the present disclosure.

FIG. 8 is a diagram illustrating an example of determining preferred resources, in accordance with aspects of the present disclosure.

FIG. 9 is a diagram illustrating an example of determining non-preferred resources, in accordance with aspects of the present disclosure.

FIG. 10 is a diagram illustrating an example of determining non-preferred resources, in accordance with aspects of the present disclosure.

FIG. 11 is a diagram illustrating an example of an Industrial IoT (IIoT) application, in accordance with aspects of the present disclosure.

FIG. 12 is a diagram illustrating an example of an IUC request, in accordance with aspects of the present disclosure.

FIG. 13 is a diagram illustrating an example of an IIoT application, in accordance with aspects of the present disclosure.

FIG. 14 is a diagram illustrating an example of an IUC message, in accordance with aspects of the present disclosure.

FIG. 15 is a diagram illustrating an example of an IIoT application, in accordance with aspects of the present disclosure.

FIG. 16 is a call flow diagram of signaling between a first UE and a second UE, in accordance with aspects of the present disclosure.

FIG. 17 is a flowchart of a method of wireless communication, in accordance with aspects of the present disclosure.

FIG. 18 is a flowchart of a method of wireless communication, in accordance with aspects of the present disclosure.

FIG. 19 is a diagram illustrating an example of a hardware implementation for an example apparatus, in accordance with aspects of the present disclosure.

FIG. 20 is a flowchart of a method of wireless communication, in accordance with aspects of the present disclosure.

FIG. 21 is a flowchart of a method of wireless communication, in accordance with aspects of the present disclosure.

FIG. 22 is a diagram illustrating an example of a hardware implementation for an example apparatus, in accordance with aspects of the present disclosure.

FIG. 23 shows a diagram illustrating an example disaggregated base station architecture.

### DETAILED DESCRIPTION

A UE may perform autonomous resource selection for sidelink transmission, which may be referred to as resource allocation mode 2 for sidelink communication. The UE may receive various types of information that may be used for sidelink resource selection. For example, the UE may perform sensing to receive sidelink resource reservations of other UEs. As another example, the UE may receive sidelink reservation information from one or more other UEs. The sidelink reservation information may include a reservation of resources from the other UEs or may include IUC information. IUC information may indicate at least one of preferred resources for sidelink transmission by the UE, non-preferred resources for sidelink transmission by the UE, or resource conflict information. The UE may include IUC information based on the reservation information/IUC information received from other UEs when transmitting its own resource reservation.

In some wireless applications, such as Industrial IoT (IIoT), a programmable logic controller (PLC) may configure or schedule communication to and from a sensor/actuator (SA). PLCs may communicate with a group of SAs that may include a plurality of SAs. In some instances, a plurality of PLCs may be present and each PLC may communicate with a corresponding group of SAs. Communications between PLCs and SAs should not interfere with communications between other PLCs and SAs. Coordination of resources at the PLC level may be advantageous in the prevention or mitigation of interference across different S As within different groups of SAs.

Aspects presented herein provide a configuration for an enhanced IUC coordination. A first UE may request an IUC message from a second UE, where the second UE senses resource reservations of nearby UEs, generates and transmits the IUC message to the first UE. The first UE may utilize the information within the IUC message to configure or schedule communication resources for a third UE, such that transmissions of the third UE do not interfere with communications of the first UE or the second UE. Aspects presented herein provide for coordination of communication resources for other UEs other than the originator of the IUC request or the originator of the IUC message, such that IUC coordination may be expanded to include additional UE within a vicinity.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

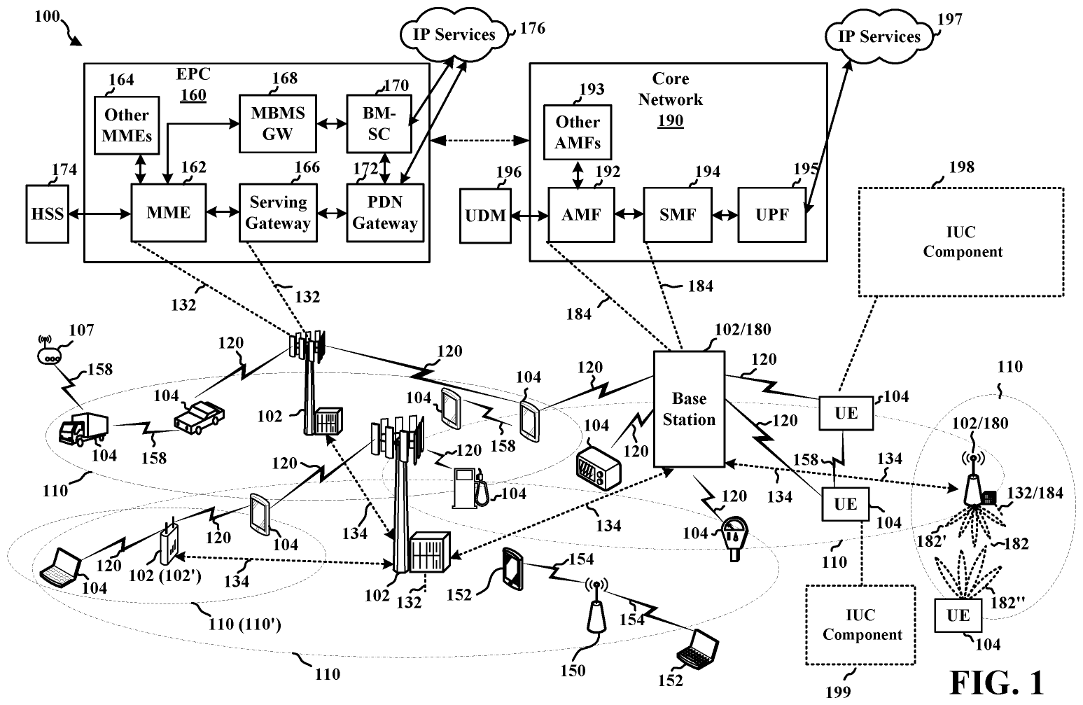

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

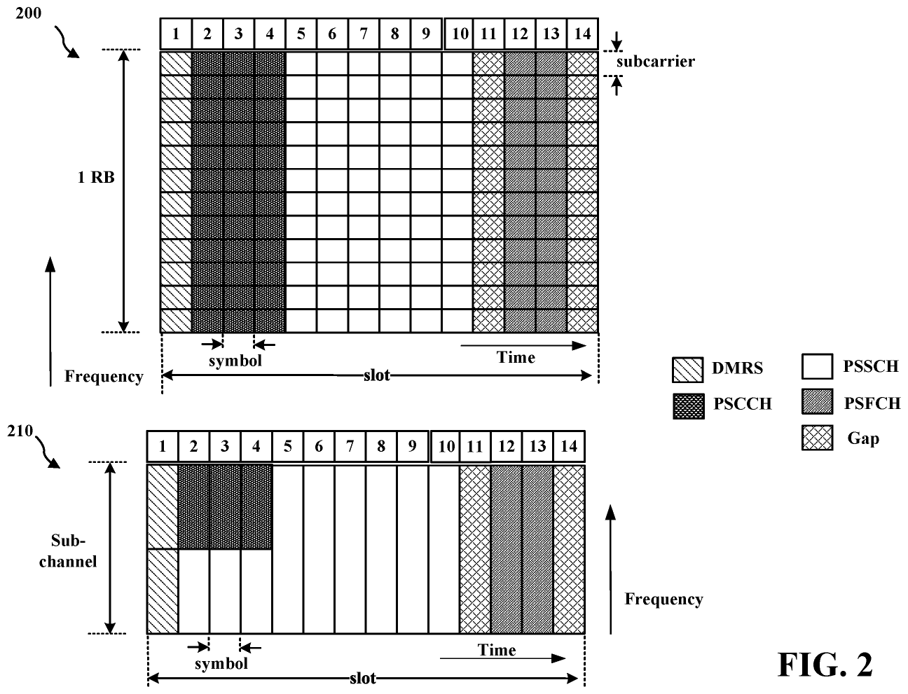

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE -A, CDMA, GSM, and other wireless technologies.

Referring again to FIG. 1, in certain aspects, the UE 104 may include an IUC component 198 configured to transmit, to a second UE, an IUC request for an IUC message indicating preferred resources or non-preferred resources for transmission of a signal by a third UE; and receive, from the second UE, the IUC message indicating the preferred resources or the non-preferred resources for the transmission of the signal by the third UE.

Referring again to FIG. 1, in certain aspects, the UE 104 may include an IUC component 199 configured to receive, from a first UE, an IUC request for an IUC message indicating preferred resources or non-preferred resources for transmission of a signal by a third UE; and transmit, to the first UE, the IUC message indicating the preferred resources or the non-preferred resources for the transmission of the signal by the third UE.

Although the following description may be focused on 5G NR, the concepts described herein may be applicable to other similar areas, such as LTE, LTE-A, CDMA, GSM, and other wireless technologies.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some aspects.

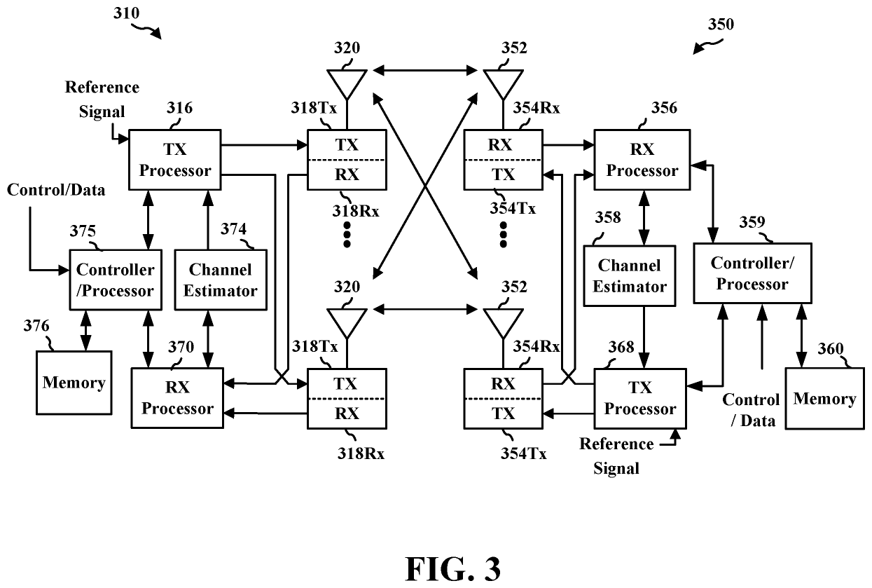

FIG. 3 is a block diagram of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318Tx. Each transmitter 318Tx may modulate an RF carrier with a respective spatial stream for transmission.

At the device 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The transmission is processed at the device 310 in a manner similar to that described in connection with the receiver function at the device 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368/316, the RX processor 356/370, and the controller/processor 359/375 may be configured to perform aspects in connection with the inter-UE coordination information component 198/199 of FIG. 1.

Sidelink communication may be based on different types or modes of resource allocation mechanisms. In a first resource allocation mode (which may be referred to herein as “Mode 1”), centralized resource allocation may be provided by a network entity. For example, a base station 102 or 180 may determine resources for sidelink communication and may allocate resources to different UEs 104 to use for sidelink transmissions. In this first mode, a UE receives the allocation of sidelink resources from the base station 102 or 180. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field comprised in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

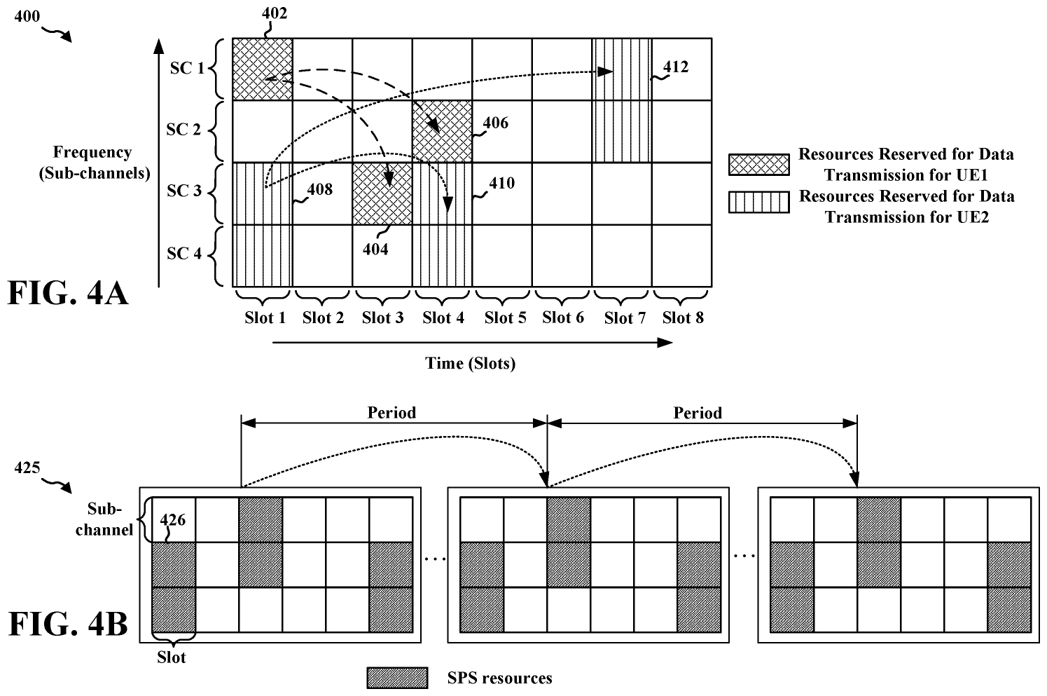

Sidelink resource reservations may be periodic or aperiodic. FIG. 4A illustrates an example 400 of time and frequency resources showing aperiodic reservations for sidelink transmissions. FIG. 4B illustrates an example 425 of periodic reservations for sidelink transmissions. The resources may be comprised in a sidelink resource pool, for example. The resource allocation for each UE may be in units of one or more sub-channels in the frequency domain (e.g., sub-channels SC1 to SC 4), and may be based on one slot in the time domain. The UE may also use resources in the current slot to perform an initial transmission, and may reserve resources in future slots for retransmissions. In this example, two different future slots are being reserved by UE1 and UE2 for retransmissions. The resource reservation may be limited to a window of time or slots. The initial candidate set of potential resources for a sidelink transmission may include 8 slots by 4 sub-channels, which provides 32 available resource blocks in total. This window may also be referred to as a resource selection window.

A first UE (“UE1) may reserve a sub-channel (e.g., SC 1) in a current slot (e.g., slot 1) for its initial data transmission 402, and may reserve additional future slots within the window for data retransmissions (e.g., 404 and 406). For example, UE1 may reserve sub-channels SC 3 at slots 3 and SC 2 at slot 4 for future retransmissions. UE1 then transmits information regarding which resources are being used and/or reserved by it to other UE(s). UE1 may do by including the reservation information in the reservation resource field of the SCI, e.g., a first stage SCI.

FIG. 4A illustrates that a second UE (“UE2”) reserves resources in sub-channels SC 3 and SC 4 at time slot 1 for its current data transmission 408, and reserve first data retransmission 410 at time slot 4 using sub-channels SC 3 and SC 4, and reserve second data retransmission 412 at time slot 7 using sub-channels SC 1 and SC 2 as shown by FIG. 4A. Similarly, UE2 may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 4A illustrates resources being reserved for an initial transmission and two retransmissions, the reservation may be for an initial transmission and a single transmission or only for an initial transmission.

FIG. 4B illustrates an example 425 of a periodic resource reservation. Periodic resource reservation and signaling may be disabled by configuration. A period, with configurable values, may be signaled in SCI. As an example, a period may have a value between 0 ms and 1000 ms. Sidelink resources may be reserved periodically, such as for SPS resources. In SPS, initial transmissions of a subsequent period in an SPS flow may be protected by an earlier SPS transmission. FIG. 4B illustrates an initial transmission may indication a resource reservation, e.g., at 426, for the SPS resources. Then, the reservation of the SPS resources in subsequent periods may be indicated by a prior SPS transmission. Transmitting a self-reservation for the initial SPS transmission of SPS traffic in subsequent periods may be redundant to the reservation indication by the prior SPS transmission.

The UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is potentially distant and a reuse of the resources is less likely to cause interference to that UE. A higher RSRP indicates that the transmitting UE that reserved the resources is potentially closer to the UE and may experience higher levels of interference if the UE selected the same resources.

For example, in a first step, the UE may determine a set of candidate resources (e.g., by monitoring SCI from other UEs and removing resources from the set of candidate resources that are reserved by other UEs in a signal for which the UE measures an RSRP above a threshold value). In a second step, the UE may select N resources for transmissions and/or retransmissions of a TB. As an example, the UE may randomly select the N resources from the set of candidate resources determined in the first step. In a third step, for each transmission, the UE may reserve future time and frequency resources for an initial transmission and up to two retransmissions. The UE may reserve the resources by transmitting SCI indicating the resource reservation. For example, in the example in FIG. 4A, the UE may transmit SCI reserving resources for data transmissions (e.g., 408, 410, and 412).

There may be a timeline for a sensing-based resource selection. For example, the UE may sense and decode the SCI received from other UEs during a sensing window, e.g., a time duration prior to resource selection. Based on the sensing history during the sensing window, the UE may be able to maintain a set of available candidate resources by excluding resources that are reserved by other UEs from the set of candidate resources. A UE may select resources from its set of available candidate resources and transmits SCI reserving the selected resources for sidelink transmission (e.g., a PSSCH transmission) by the UE. There may be a time gap between the UE's selection of the resources and the UE transmitting SCI reserving the resources.

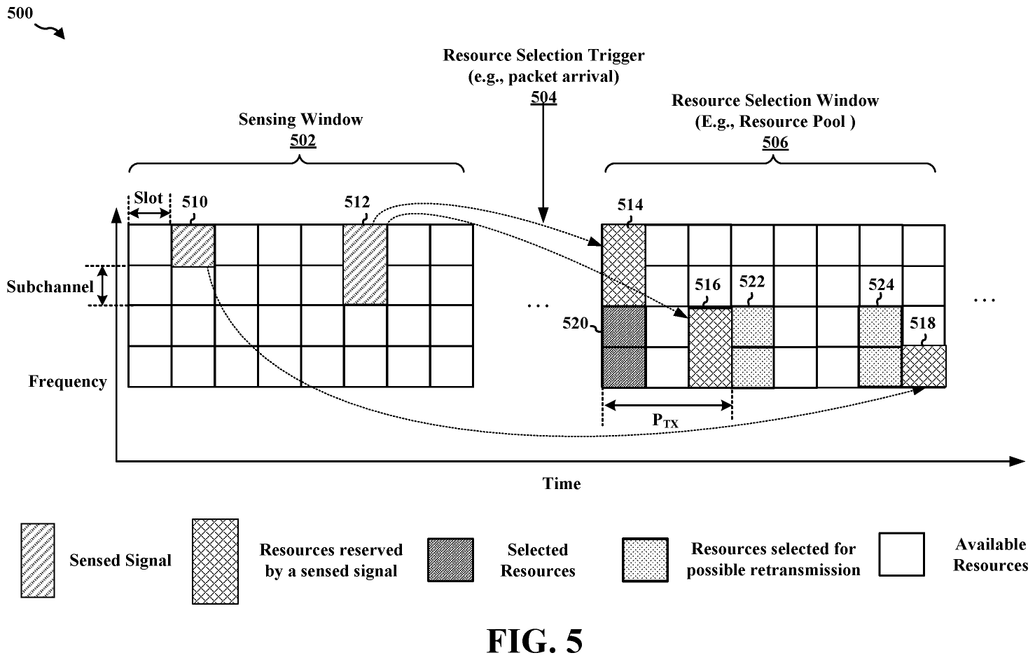

FIG. 5 illustrates an example timeline 500 for sidelink resource selection based on sensing. In FIG. 5, the UE may receive sidelink transmission 510 and sidelink transmission 512 during the sensing window 502. FIG. 5 illustrates an example sensing window including 8 consecutive time slots and 4 consecutive sub-channels, which spans 32 resource blocks. The sidelink transmission 510 indicates a resource reservation for resource 518, and sidelink transmission 512 indicates a resource reservation for resources 514 and 522. For example, the sidelink transmissions 510 and 512 may each include SCI that indicates the corresponding resource reservation. Resource reservations may be periodic or aperiodic. Different reservations of resources may have different priority levels, e.g., with the priority level indicated in the SCI.

A UE receiving the transmissions 510 and 512 may exclude the resources 514, 516, and 518 as candidate resources in a candidate resource set based on the resource selection window 506. In some examples, the sidelink device may exclude the resources 514, 516, or 518 based on whether a measured RSRP for the received SCI (e.g., in 510 or 512) meets a threshold. When a resource selection trigger occurs at 504, such as the sidelink device having a packet for sidelink transmission, the sidelink device may select resources for the sidelink transmission (e.g., including PSCCH and/or PSSCH) from the remaining resources of the resource pool within the resource selection window 506 after the exclusion of the reserved resources (e.g., 514, 516, and 518). FIG. 5 illustrates an example in which the sidelink device selects the resource 520 for sidelink transmission. The sidelink device may also select resources 522 and/or 524 for a possible retransmission. After selecting the resources for transmission, the sidelink device may transmit SCI indicating a reservation of the selected resources. Thus, each sidelink device may use the sensing/reservation procedure to select resources for sidelink transmissions from the available candidate resources that have not been reserved by other sidelink devices

In some instances, multiple UEs may transmit at the same time and may not receive the overlapping communication (e.g., SCI indicating resource reservations) from each other and/or from a base station. Such a UE may miss or be unaware of transmissions and sidelink reservations by other UEs. Therefore, two UEs may reserve the same resource block for a future sidelink transmission, which may result in a resource collision. A resource collision occurs for sidelink transmissions that overlap at least partially in time, and which may overlap, at least partially, in frequency.

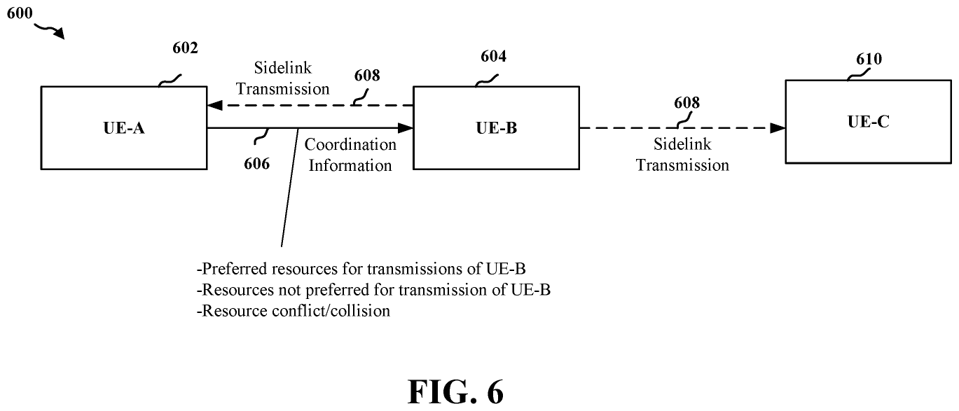

To reduce or avoid resource collisions under such instances, and to improve sidelink communication among UEs, the UEs may coordinate among themselves by generating and sharing inter-UE coordination information signaling with other UEs. FIG. 6 is a diagram 600 illustrating the exchange of inter-UE coordination information, where a first UE (“UE-A” 602) transmits inter-UE coordination information 606, e.g., in a coordination message over sidelink, to a second UE (“UE-B”) 604. In some aspects, the transmission of inter-UE coordination information may include resource reservation forwarding by the UE-A.

The inter-UE coordination information 606 may include information based on the UE's sensing information (e.g., resource reservations of other UEs that are sensed by UE-A 602), inter-UE coordination information from another UE, resources that are bad, undesirable, or non-preferred for the UE-A 602 (e.g., resources subject to high interference), resources which are preferred or better than other resources for the UE-A 602, etc. The UE-A 602 may determine a set of sidelink resources available for a resource allocation. The UE-A 602 may determine the set of sidelink resources based at least in part on determining that the set of sidelink resources are to be selected or based at least in part on a request, referred to herein as an inter-UE coordination request, received from the UE-B 604 or a base station. The UE-A 602 and the UE-B 604 may operate in an in-coverage mode, a partial coverage mode, or an out-of-coverage mode with a base station, for example. In some aspects, the UE-A 602 may determine the set of sidelink resources based at least in part on a sensing operation, which may be performed before receiving an inter-UE coordination request or after receiving the inter-UE coordination request. In some aspects, the UE-A 602 may determine the set of sidelink resources based at least in part on a satisfaction of one or more conditions.

The inter-UE coordination information 606 may indicate candidate resources for sidelink transmission or preferred resources for transmissions by UE-B 604. The UE-A 602 may use the inter-UE coordination information 606 to inform the UE-B 604 about which sub-channels and slots may be used for communicating with the UE-A 602 and/or which sub-channels and slots may not be used because they are occupied or reserved by the UE-A 602 and/or other UEs. The UE-A may indicate a set of resources that may be more suitable for UE-B's transmission based on UE-A's evaluation. The candidate resources may indicate a group of resources from which the UE-B 604 (e.g., UE-B) may select for the sidelink transmission 608. As illustrated, the sidelink transmission 608 may be for UE-A 602 or for one or more different UEs, e.g., UE-C 610. In some aspects, the UE-A may be a potential receiver of the UE-B's transmission, and the inter-UE coordination information may enable mode 2 resource allocation that is based on resource availability from a potential receiver's perspective, which may address reception challenges for a hidden node. In some aspects, the inter-UE coordination information 606 may indicate resources for a sidelink transmission, e.g., particular resources on which the UE-B 604 is to transmit the sidelink transmission 608 rather than candidate resources that the UE-B 604 may select.

The UE-A 602 may transmit an indication of the set of available resources to the UE-B 604 via inter-UE coordination signaling (shown as a coordination message, and referred to in some aspects as an inter-UE coordination message or inter-UE coordination information). In some aspects, the UE-A 602 may transmit the indication of the set of available resources while operating in NR sidelink resource allocation mode 2. In NR sidelink resource allocation mode 2, resource allocation is handled by UEs (e.g., in comparison to NR sidelink resource allocation mode 1, in which resource allocation is handled by a scheduling entity, such as a base station). In some aspects, the set of available resources may be included in a resource pool. The resource pool may include a plurality of resources that may be used by the UEs (e.g., the UE-A 602 and the UE-B 604) for respective transmissions and receptions. For example, the resource pool may include a set of time and frequency resources that are reserved to be used for inter-UE communications (e.g., sidelink communications). In some aspects, the indication of the set of available resources may identify resources that are preferred by the UE-A 602 for transmissions by the UE-B 604. In some aspects, the inter-UE coordination information 606 may indicate a set of resources that may not be preferred for UE-B's transmission, such as resources that may not be available for UE-B to transmit a sidelink transmission based on the UE-A's evaluation.

In some aspects, the inter-UE coordination information 606 may indicate a half-duplex conflict. For example, the inter-UE coordination information 606 may indicate a collision in time and/or frequency for two transmitting UEs that are unable to receive the other, respective transmission in a half-duplex mode. In some aspects, the inter-UE coordination information 606 may indicate a collision of resources (e.g., reserved resources) in time and/or frequency. The inter-UE coordination signaling may indicate a resource conflict (e.g., a collision), such as when two UEs have reserved the same resource (e.g., and were unable to detect this conflict because the two UEs transmitted a resource reservation message on the same resource and thus did not receive one another's resource reservation messages due to a half-duplex constraint). Based at least in part on the inter-UE coordination information 606 from the UE-A 602, the UE-B 604 may make a better decision on which resources to use and/or reserve for its sidelink transmission 608 to avoid resource collisions. The UE-B 604 may select a sidelink resource for a transmission from the UE-B 604 based at least in part on the set of resources being available or not available indicated by the UE-A 602. As shown, the UE-B 604 may account for the coordination information when transmitting (e.g., via a sidelink resource indicated as available or not available by the inter-UE coordination message). Inter-UE coordination signaling related to resource allocation may increase a packet reception rate at the UE-A 602, and may reduce a power consumption for the UE-A 602 and/or the UE-B 604 (e.g., due to fewer retransmissions as a result of fewer collisions).

The UE-A 602 may share its inter-UE coordination information 606 with multiple UEs, and the UE-B 604 may receive the inter-UE coordination information 606 from multiple UEs. Inter-UE coordination information 606 may be transmitted in any of various ways. For example, although FIG. 3 shows a single UE-A 602 transmitting inter-UE coordination information to a single UE-B 604, in some aspects, a single UE-A 602 may transmit inter-UE coordination information to multiple UEs to assist those UEs with selecting resources for transmissions. Additionally, or alternatively, the UE-B 604 may receive inter-UE coordination information from multiple UEs, and may use that information to select resources for a transmission (e.g., resources that avoid a conflict with all of the multiple UEs or as many as possible).

The UE-A 602 may transmit inter-UE coordination information 606 in a PSFCH, e.g., indicating a resource collision or a half-duplex conflict indication. The UE-A 602 may transmit inter-UE coordination information 606 in SCI. For example, the UE-A 602 may transmit shared sensing information, candidate resource information for a sidelink transmission, or particular resources for a sidelink transmission in SCI-2 transmitted in PSSCH. For example, a first portion of SCI (e.g., SCI-1) may be transmitted in PSCCH, and a second portion of SCI (e.g., SCI-2) may be transmitted in PSSCH. The UE-A 602 may transmit inter-UE coordination information 606 in a MAC-CE, e.g., on the PSSCH. The UE-A 602 may transmit the inter-UE coordination information 606 in a new physical channel (e.g., that is different than PSCCH, PSSCH, PSFCH, etc.). For example, the UE-A 602 may transmit the inter-UE coordination information 606 in a physical channel that is configured for or dedicated to inter-UE configuration information. The UE-A 602 may transmit the inter-UE coordination information 606 in RRC signaling.

In some aspects, an indication of the resource reservation may be transmitted using an entry-based format or a bitmap-based format. The UE-A 602 may be configured to determine whether to transmit the indication of the resource reservation using the entry-based format, or the bitmap-based format, based at least in part on a number of conditions, such as a configuration of the resource pool, a periodicity of the resource reservation, a size of the resource reservation, or whether the resource reservation is multiplexed with other data, as described further herein.

In some aspects, the UE-A 602 may transmit the inter-UE coordination information 606 periodically. In some aspects, the UE-A 602 may transmit aperiodic inter-UE coordination information 606 in response to a trigger. Among other examples, the trigger may be based on the occurrence of an event, such as the occurrence of/detection of a resource collision, the occurrence of/detection of a half-duplex conflict, etc. For example, if the UE-A 602 detects a resource collision, the UE-A 602 may respond by transmitting inter-UE coordination information 606.

In a first scheme, the coordination information 606 sent from UE-A 602 to UE-B 604 is the set of resources preferred and/or non-preferred for UE-B's transmission 608. In some aspects. In some aspects, the inter-UE coordination information 606 may include additional information other than indicating time/frequency of the resources within the set in the coordination information.

In a second scheme, the inter-UE coordination information 606 from UE-A 602 to UE-B 604 indicate the presence of an expected/potential and/or detected resource conflict on the resources indicated by an SCI from UE-B 604.

The UE-B 604 may utilize the inter-UE coordination information 606 in various ways. If the inter-UE coordination information 606 includes information based on the first scheme (e.g., resources that are preferred for transmissions of the UE-B 604 and/or resources that are not preferred for transmissions of the UE-B 604), the UE-B 604 may select resource(s) to be used for its sidelink transmission resource selection, or resource re-selection, may be based on both UE-B's sensing result (if available) and the received inter-UE coordination information 606 according to a first option. In a second option, the UE-B 604 may select resource(s) to be used for its sidelink transmission resource selection, or resource re-selection, may be based on the received inter-UE coordination information 606 and not based on sensing. In a third option, the UE-B 604 may select resource(s) to be used for its sidelink transmission resource selection, or resource re-selection, may be based on the received inter-UE coordination information 606 (which may allow the UE-B to use or not use sensing in combination with the inter-UE coordination information 606)

If the inter-UE coordination information 606 includes information based on the second scheme (e.g., information indicating a resource conflict), the UE-B 604 may determine resources to be re-selected based on the received inter-UE coordination information 606. The UE-B 604 may determine whether to perform a retransmission based on the received inter-UE coordination information 606. In some aspects, the UE-B 604 may use sensing information in combination with the inter-UE coordination information 606 to determine resources to be re-selected and/or to determine whether to perform a retransmission.

In a first inter-UE coordination scheme, the coordination information that is sent from UE-A to UE-B may include the set of resources that are preferred or non-preferred for the UE-B's transmission. Down selection may be performed between the preferred resource set and the non-preferred resource set. The inter-UE coordination information may indicate a time/frequency of the resources within the set and may further include additional information.

In a second inter-UE coordination scheme, the coordination information that is sent from the UE-A to the UE-B may include the presence of expected/potential and/or detected resource conflicts on the resources indicated by SCI from the UE-B. In some aspects, down-selection may be performed between the expected/potential conflict and the detected resource conflict.

In some aspects, the UE-A that transmits the inter-UE coordination information to the UE-B may be a particular UE, such as an intended receiver of UE-B. In some aspects, any UE may transmit inter-UE coordination information. In some aspects, a UE may be configured, such as in a higher-layer configuration, to transmit inter-UE coordination information.

In some aspects, the UE-A may be triggered to transmit the inter-UE coordination information based on the occurrence of a condition. In some aspects, the condition may be reception of a request for the inter-UE coordination information. In some aspects, the condition may be different than reception of a request in Mode 2. In some aspects, the transmission of inter-UE coordination information may be enabled, disabled, or otherwise controlled through a configuration of the UE.

As an example of a condition, the UE-A may transmit the inter-UE coordination information if reserved resource(s) of other UE(s) identified by the UE-A whose RSRP measurement is larger than a configured RSRP threshold, the RSRP threshold determined by at least priority value indicated by SCI of the UE(s). As another example of a condition, the UE-A may transmit the inter-UE coordination information if the resources reserved by another UE have an RSRP measurement that is smaller than a configured RSRP threshold, the RSRP threshold being determined by at least a priority value indicated by SCI of the UE(s) and the UE-A sending the inter-UE coordination information is a destination of a transport block (TB) transmitted by the UE(s). As another example of a condition, the UE-A may transmit inter-UE coordination information indicating a non-preferred resource set if the UE-A is the intended receiver of the UE-B, and does not expect to perform sidelink reception based on a half-duplex operation.

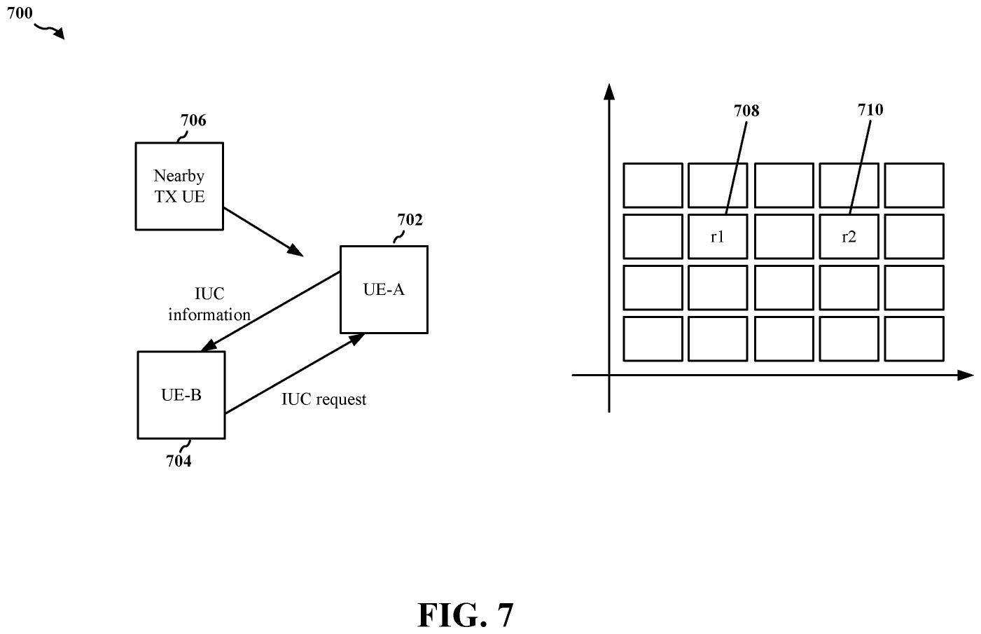

In some aspects, for example as shown in diagram 700 of FIG. 7, the UE-A 702 may prefer or not prefer a resource, and the UE-B 704 should be informed of the preferred and the non-preferred resources. For example, a nearby transmitting UE 706 may reserve resource r1 708 for its own transmission. In order for UE-A 702 to determine whether a resource is preferred or non-preferred, the UE-A 702 may determine if other nearby transmitting UEs (e.g., UE 706) are reserving the resource. UE-A 702 may determine if the other nearby transmitting UEs (e.g., UE 706) are reserving the resource by sensing or monitoring the channel for reservation SCIs from any sidelink transmitting UEs (e.g., UE 706) within the vicinity of UE-A 702. In some instances, the UE-A 702 may receive a transmission from the nearby UE 706 having a high reference signal received power (RSRP) or an RSRP that exceeds a threshold. In such instances, if the UE-A 702 is the intended target UE to receive a transmission from UE-B 704, then the UE-A 702 prefers UE-B 704 to use another resource (e.g., r2 710), other than resource rl 708, to perform the transmission such that UE-A 702 does not receive the transmission from UE-B 704 and the transmission from the nearby UE 706 within the same resource, which may reduce or minimize interference.

In some instances, the UE-A 702 may receive a transmission from the nearby UE 706 having a low reference signal received power (RSRP) or an RSRP that does not exceed a threshold. In such instances, if the UE-A 702 is the intended target UE to receive a transmission from the nearby UE 706, then the UE-A 702 does not prefer UE-B 704 to use resource r1 708 to perform the transmission. If UE-B 704 transmits in resource r1 708, then UE-B's transmission will interfere with the transmission from the nearby UE 706.

The UE-A may assume or know properties of the UE-B intended transmission so that the UE-A may perform channel sensing to determine whether the resources are preferred. The UE-A may perform PHY layer channel sensing to determine the available resources. UE-A should know the properties of UE-B's intended transmission to determine whether a resource is available or not for transmission. For example, an RSRP threshold may be based on a priority of the transmission from UE-B. This may enable transmission resource selection based on the target UE performing channel sensing.

For the UE-A to determine non-preferred resources, the UE-A does not need to know any of the properties of UE-B's intended transmission. The UE-A may measure the RSRP of nearby transmitting UEs and determine their transmission priority and resource reservation. This may enable target UE assisted transmission resource selection.

Preferred resources may be determined based on certain conditions. For example, a first condition may be related to resources excluding those overlapping with reserved resources of other UEs identified by UE-A whose RSRP measurement is larger than a RSRP threshold. A set of resources preferred for UE-B's transmission may be a form of candidate single-slot resources. In some instances, if the IUC information or message transmission is triggered by a request from UE-B, the UE-B may signal at least the following parameters to UE-A: Priority value of PSCCH/PSSCH, a number of subchannels of PSCCH/PSSCH, resource reservation interval, or starting/ending times of resource selection window. In some instances, if the IUC information or message transmission is triggered by a condition, values of the following parameters may be (pre)configured for a resource pool for determining preferred resource. If there is no (pre)configuration, UE-A may determine the values of the following parameters: prio_{TX}, L_{subCH}, P_{rsvp_TX}. In addition, UE-A may determine values of following parameters: n+T₁, n+T₂ (resource selection window).

A second condition may be related for instances where UE-A is the intended receiver of a transmission from UE-B. In such instances, the set of resources preferred for UE-B's transmission may be a form of candidate single-slot resources. The UE-A may exclude candidate single-slot resources associated to slots where UE-A, when it is intended receiver of UE-B, does not expect to perform sidelink reception from UE-B due to half duplex operation.

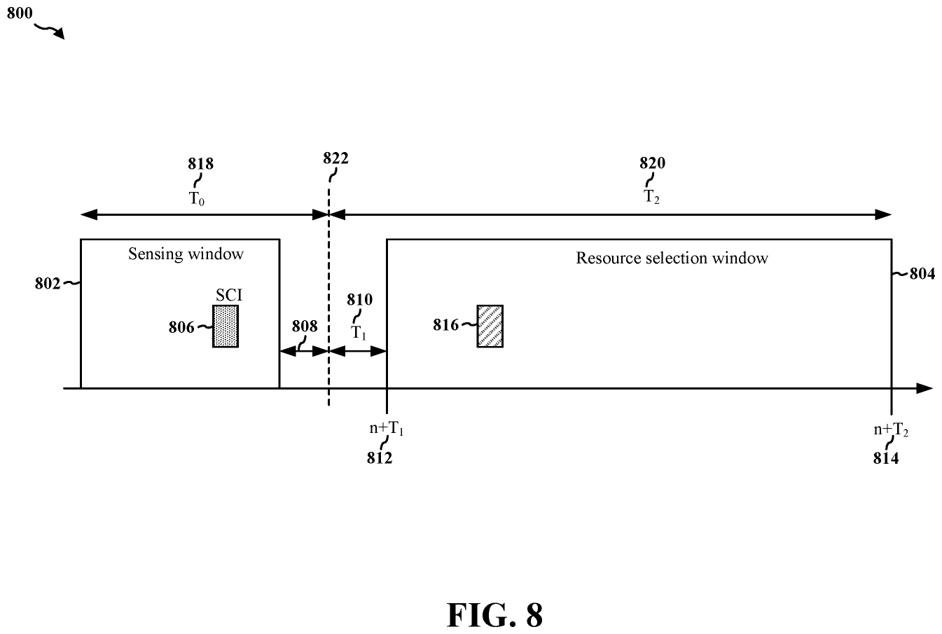

FIG. 8 provides a diagram 800 of determining preferred resources. UE-A may sense or receive for one or more SCIs 806 from nearby transmitting UEs. UE-A sensing for the one or more SCIs may be triggered by receiving an IUC request from UE-B. The IUC request from UE-B may comprise one or more sensing parameters for UE-A. In some instances, the SCI 806 may be associated for a transmission to another UE (not shown) as its target UE. UE-A may receive the SCI 806 within the sensing window 802. The sensing window 802 may be based on a resource selection trigger 822 of the UE-A and a sensing timer To 818. The sensing window 802 may end at a time 808 prior to the resource selection trigger 822. The time 808 may allow a period of time for the UE-A to process a sidelink transmission that triggers the resource selection trigger 822. A determination of resource 816 being an available resource may be based on at least the RSRP of the SCI 806, a priority indicated in the IUC request from the UE-B, or a priority indicated in the SCI 806. The resource 816 may be selected within the resource selection window 804. The resource selection window may be based on the resource selection trigger 822 of the UE-A. For example, upon the occurrence of the resource selection trigger 822 for a sidelink slot n, the resource selection window 804 may start at a start time 812 which may include n+T₁, where a value of T1 810 may be configurable or preconfigured. The ending time 814 of the resource selection window may comprise n+T₂, where T2 820 is a period of time starting from the resource selection trigger 822. The values of n+T₁ for the start time 812 and/or n+T₂ for the ending time 814 may be configurable or preconfigured.

In the aspect of FIG. 8, the UE-A may receive a nearby transmitting UE's SCI 806 which contain resource reservations. If the UE-A receives the SCI 806 having an RSRP that is greater than an RSRP threshold, which may be based on the priority of the SCI 806 and a priority indicated in the IUC request of the UE-B, then UE-A may determine the reserved resource 816 as not preferred. As such, other resources within the resource selection window 804 may be considered as preferred resources.

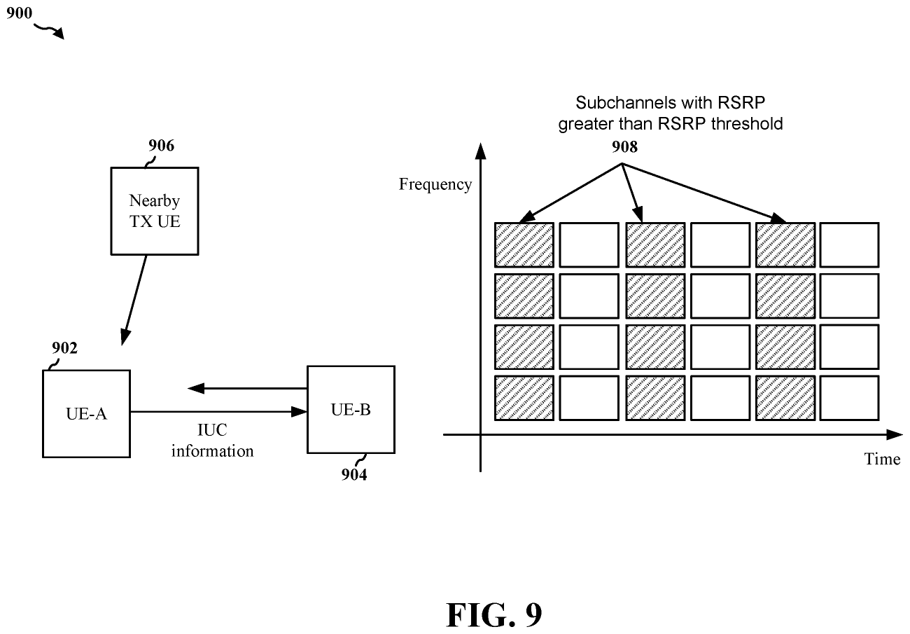

Non-preferred resources may be determined based on certain conditions. For example, a first condition may be related to reserved resources of other UE identified by UE-A having an RSRP measurement that is greater than an RSRP threshold. The RSRP threshold may be determined by at least priority value indicated by SCI of the other UE. For example, with reference to diagram 900 of FIG. 9, in instances where UE-A 902 is the target UE or intended recipient for a transmission from UE-B 904, UE-B should not transmit its transmission to UE-A using the non-preferred resources because doing so would result in UE-B's transmission being interfered by transmissions from the other UEs 906, such that UE-A is less likely to receive the transmission from UE-B due to the interference from the other UE. If the RSRP of the transmission from the other UE is high (e.g., subchannels 908), then the UE-B should not transmit in the same resource due to interference form the other UE. The RSRP threshold may be based at least on the other UE 906 priority. In such instances, the subchannels 908 may be determined to be non-preferred resources.

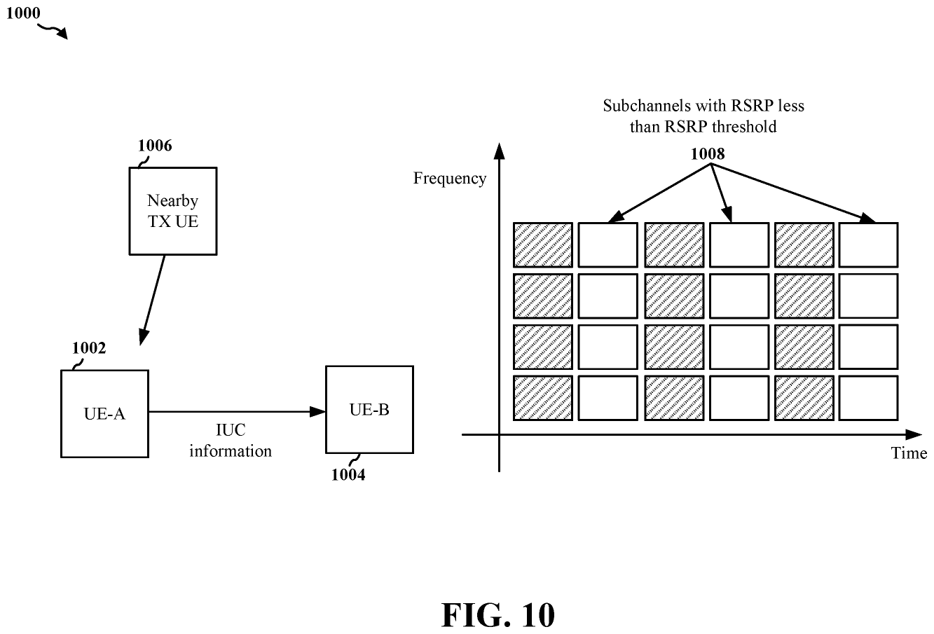

In some instances, reserved resources of other UE identified by UE-A having an RSRP measurement less than an RSRP threshold. The RSRP threshold may be determined by at least a priority value indicated by SCI of the other UE when UE-A is a destination of a transmission transmitted by the other UE. The RSRP threshold may be configurable or preconfigured. For example, with reference to diagram 1000 of FIG. 10, in instances where UE-A 1002 is the target UE or intended recipient of a transmission from the other UE 1006, UE-B 1004 should not transmit in the reserved resources of the other UE 1006 because such resources are being utilized by UE-A 1002 to receive the transmission from the other UE 1006. If the RSRP of the transmission from the other UE is low (e.g., subchannels 1008), then UE-B should not transmit in the same resource, otherwise, UE-B's transmission will cause interference to UE-A's reception of the transmission from the other UE. In such instances, the subchannels 1008 may be determined to be non-preferred resources.

In some instances, a second condition may be based on situations where the UE-A is the intended recipient of a transmission from UE-B. For example, resources (e.g., slots) where UE-A, when it is intended receiver of UE-B, does not expect to perform sidelink reception from UE-B due to half duplex operation.

Table 1 provides an example of a SCI.

TABLE 1

| Field name | Field size (in bits) |
|---|---|
| Providing/requesting | 1 |
| indicator | |
| Priority | 3 |
| Number of | ┌log₂(N_{subChannel}^{SL})┐ |
| subchannels | Where N_{subChannel}^{SL} is provided by the higher layer parameter sl-NumSubchannel |
| Resource reservation | Y |
| period | Where Y = ┌log₂ Nᵣₛᵥ_{_{—}}_{period}┐with that Nᵣₛᵥ_{_{—}}_{period} is the number of entries in the |
| | higher layer parameter sl-ResourceReservePeriodList, if higher layer parameter |
| | sl-MultiReserveResoure is configured; Y = 0 otherwise. |
| Resource selection | 2(10 + ┌log₂(10 · 2^{μ})┐) |
| window location | Where μ is 0, 1, 2, 3 for SCS of 15 kHz, 30 kHz, 60 kHz, 120 kHz, respectively. |
| Resource set type | 1 bit if determineResourceSetTypeScheme1 is set to ‘UE-B's request’, otherwise, 0 bit |

The example of the SCI of Table 1 may comprise a SCI format 2-C/MAC-CE for an IUC request. A resource pool level configuration may enable a MAC-CE and 2^{nd} stage SCI used as a container of an explicit request transmission from UE-B to UE-A. When both SCI format 2-C and MAC-CE are used as the container of an explicit request for inter-UE coordination information, the same bit field size for the request in a SCI format 2-C may be applied to the MAC-CE. The SCI 2-C is optional for a receiver UE. The UE may use the 2^{nd} SCI for UE-B. In some aspects, the resource pool level configuration may enable a MAC-CE to be used as the container of an explicit request transmission from UE-B to UE-A. When MAC-CE is only used as the container of an explicit request for an IUC information or message, the same bit field size for the request in a SCI format 2-C may be applied to MAC-CE. With reference to Table 1, the UE-B's intended transmission parameters may be comprised within the number of subchannels, resource reservation period, and the resource selection window location within the SCI of Table 1. The resource selection window location may provide information related to start time (e.g., slots n+T₁) and the ending time (e.g., n+T₂) for the resource selection window. The resource set type may include information related to the preferred or non-preferred resource set.

Table 2 provides an example of MAC-CE for an IUC message.

TABLE 2

| Field name | Field size (in bits) |
|---|---|
| Providing/requesting indicator | 1 |
| Resource combination(s) | $N * \{ ⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ + 9 + Y \}$ |
| | Where N_{subChannel}^{SL} is provided by the higher layer parameter sl-NumSubchannel, |
| | Y = ┌log₂ Nᵣₛᵥ_period┐ with that Nᵣₛᵥ_period is the number of entries in the higher |
| | layer parameter sl-ResourceReservePeriodList, if higher layer parameter sl- |
| | MultiReserveResoure is configured; Y = 0 otherwise. |
| First resource | (N − 1) * ┌log₂(X)┐ |
| location(s) | Where X is provided by the (pre)configured maximum value of slot offset for the case when |
| | MAC CE only is used as a container of inter-UE coordination information |
| Reference slot | 10 + ┌log₂(10 · 2^{μ})┐ |
| location | Where μ is 0, 1, 2, 3 for SCS of 15 kHz, 30 kHz, 60 kHz, 120 kHz, respectively. |
| Resource set type | 1 |
| Lowest subchannel | N * ┌log₂(N_{subChannel}^{SL})┐ |
| indices for the first | Where N_{subChannel}^{SL} is provided by the higher layer parameter sl-NumSubchannel. |
| resource location of | |
| each TRIV | |

A maximum value of N resource combinations to be conveyed in IUC information may be bounded so that the total payload size of IUC does not exceed the size of TB including the MAC-CE. A slot offset, which may be configured or preconfigured, to indicate the first resource location of each time resource indicator value (TRIV) with respect to a reference slot, the granularity of the slot offset is 1 logical slot, or may be configurable or preconfigured to a maximum value of up to 8000. In some instances, when both SCI format 2-C and MAC-CE are used as the container of IUC information, the maximum value of the slot offset is 255. In some instances, when MAC-CE is only used as the container of IUC information, the maximum value of the slot offset is the (pre)configured maximum value.

Upon reception of IUC information, UE-B can base its transmission resource selection on the sensing results and received IUC information, or only on received IUC information (e.g., preferred resources). For example, in instances where the UE-B receives preferred resources in the IUC information, the selection of transmission resources being based on the IUC, which may result in receiver UE sensing based transmission resource selection. In some instances, where the UE-B receives preferred resources in the IUC information, the selection of transmission resource being based on the IUC and sensing performed by UE-B, may result in receiver UE sensing based transmission resource selection and the MAC of the UE-B selecting transmission resources based on the sensing results and the IUC.

In some aspects, such as when the UE-B receives non-preferred resources in the IUC information, the selection of transmission resources may be based on sensing performed by the UE-B and the IUC, which may result in receiver UE assisted transmission resource selection and the UE-B's PHY eliminating non-preferred resources from the sensing results before reporting the sensing results to the MAC.

In instances where the UE-B receives the IUC information comprising a preferred resource set, the UE-B resources used for its transmission resource selection may be based on both UE-B's sensing result (if available) and the received IUC information. UE-B may use in its resource selection, resources belonging to the preferred resource set in combination with its own sensing result. UE-B may use in its resource selection, resources that do not belong to the preferred resource set when conditions are met. The MAC layer selects resources using a sensing algorithm and the received preferred resource set. The MAC layer may first select resources for transmissions within the intersection of sensing algorithm and the preferred resource set until it becomes impossible to select a resource within the intersection. After this, if the number of selected resources is less than the required number of transmissions for a TB, the MAC layer selects resources for the remaining transmissions outside the intersection but inside the sensing algorithm. In some aspects, UE-B's resources used for its transmission resource selection may be based on the received IUC information. The UE-B may use in its resource selection, resources that belong to the preferred resource set.

In instances where the UE-B receives the IUC information comprising a non-preferred resource set, the UE-B's resources used for its transmission resource selection may be based on both UE-B's sensing result (if available) and the received IUC information. The PHY layer at the UE-B may remove non-preferred resources in its resource selection.

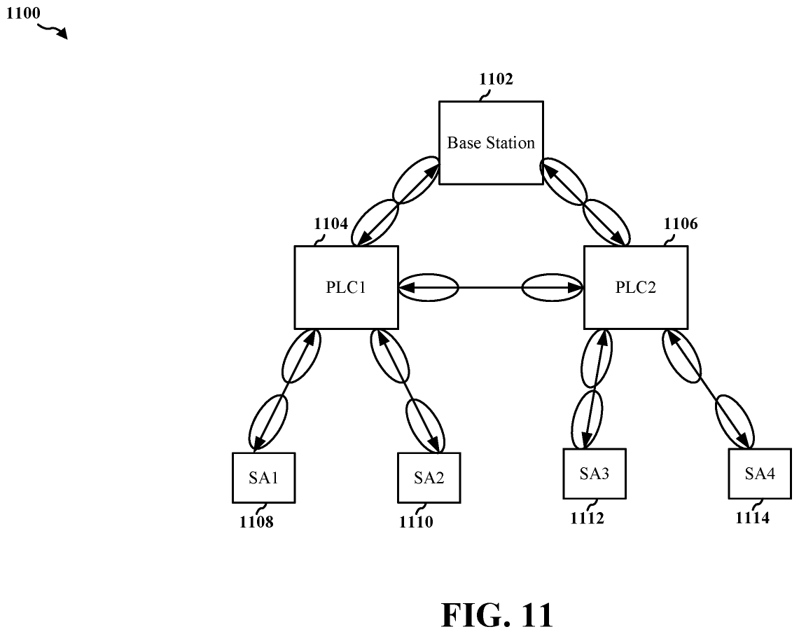

FIG. 11 is a diagram 1100 of an Industrial IoT (IIoT) application. The diagram 1100 includes a base station 1102, programmable logic controllers PLC1 1104, a PLC2 1106, sensor/actuator SA1 1108, SA2 1110, SA3 1112, and SA4 1114. The base station 1102 may communicate with each of the PLC1 1104 and the PLC2 1106. The PLC1 1104 and PLC2 1106 may communicate with each other, the base station 1102 and a corresponding group of SAs. In the diagram 1100, PLC1 1104 has SA1 1108 and SA2 1110 within its group of SAs, while PLC2 1106 has SA3 1112 and SA4 1114 within its group of SAs. Each of the SAs within the group of SAs may communicate with the corresponding PLC.

In some instances, when PLC1 1104 is transmitting to its SAs (e.g., SA2 1110), a transmission from PLC1 1104 should not interfere with communication between PLC2 1106 and PLA2's SAs (e.g., SA3 1112). To mitigate potential interference, PLC1 1104 should be aware of SA3 1112 non-preferred resources for a PLC1 transmission. In some instances, when SA2 1110 is transmitting to PLC1, transmissions form SA2 should not interfere with communication between PLC2 and PLC2's SAs. To mitigate potential interference, PLC1 should be aware of SA3's and PLC2's non-preferred resources for SA2's transmission, where PLC1 schedules the transmission for SA2.

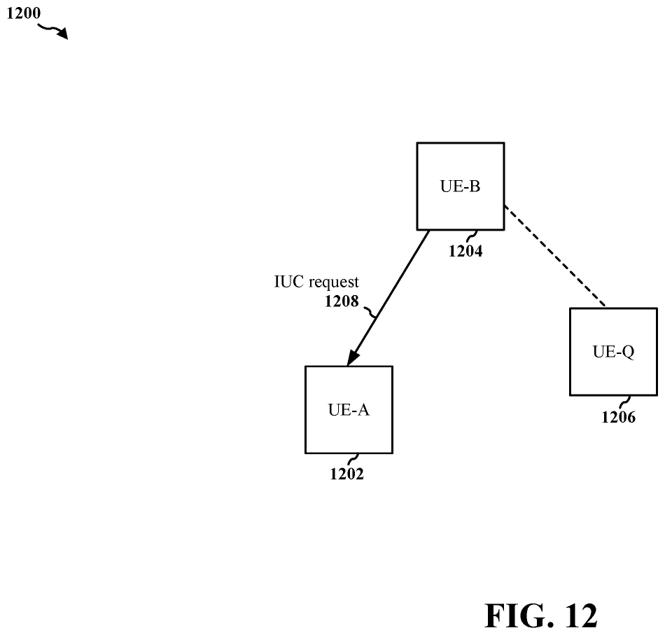

FIG. 12 illustrates an example of an IUC request. The diagram 1200 of FIG. 12 includes a UE-A 1202, a UE-B 1204, and a UE-Q 1206. The UE-Q 1206 may be a UE within the vicinity of at least one of UE-B or UE-A. The UE-B 1204 may send a IUC request 1208 to the UE-A. The IUC request may identify the source UE of the IUC request (e.g., UE-B). The IUC request may identify the UE from whom the IUC information or message is request (e.g., UE-A). The IUC request may further identify the transmitting UE for whom the requested IUC information or message applies. For example, in the example of FIG. 12, the UE-B requests UE-A to provide non-preferred resources for a transmission transmitted by UE-Q. Upon receipt of the IUC request, the UE-A may determine non-preferred resources for a transmission by UE-Q, instead of determining non-preferred resources for a transmission performed by UE-B. UE-B may configure or schedule the transmission of UE-Q, and the IUC information from UE-A may assist UE-B in the selecting or scheduling of resources for UE-Q's transmission.

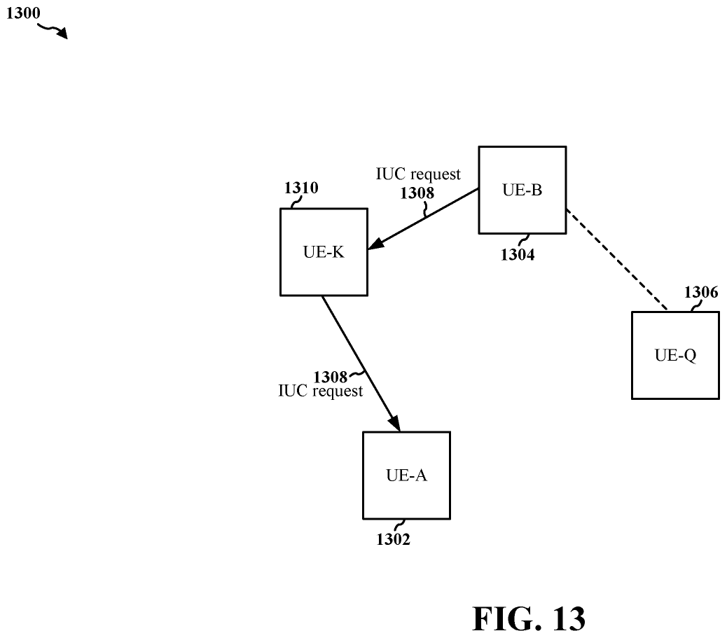

FIG. 13 illustrates an example of an IIoT application. The diagram 1300 of FIG. 13 includes a UE-A 1302, a UE-B 1304, a UE-Q 1306, and a UE-K 1310. In the example of FIG. 13, UE-B is the originator of the IUC request 1308, which may request non-preferred resources for UE-Q's transmission. The IUC request 1308 may be relayed from UE-K 1310 to UE-A 1302. In some aspects, UE-K may comprise a PLC (e.g., 1104 or 1106 of FIG. 11), while UE-A may comprise an SA (e.g., SA3 1112), while UE-Q may comprise an SA (e.g., SA2 1110). In addition to the existing fields of the IUC, discussed above, the IUC request may further include an originator of the IUC request (e.g., UE-B 1304), a destination or target UE of the IUC request (e.g., UE-A 1302), or a transmitter UE (e.g., UE-Q 1306) that will be utilizing the non-preferred resources as determined by the target UE (e.g., UE-A). The UE-Q should not cause interference to UE-A receptions. The UE-B (e.g., PLC1 1104) should have knowledge of UE-A (e.g., SA3 1112) non-preferred resources for UE-Q (e.g., SA2 1110) transmissions.

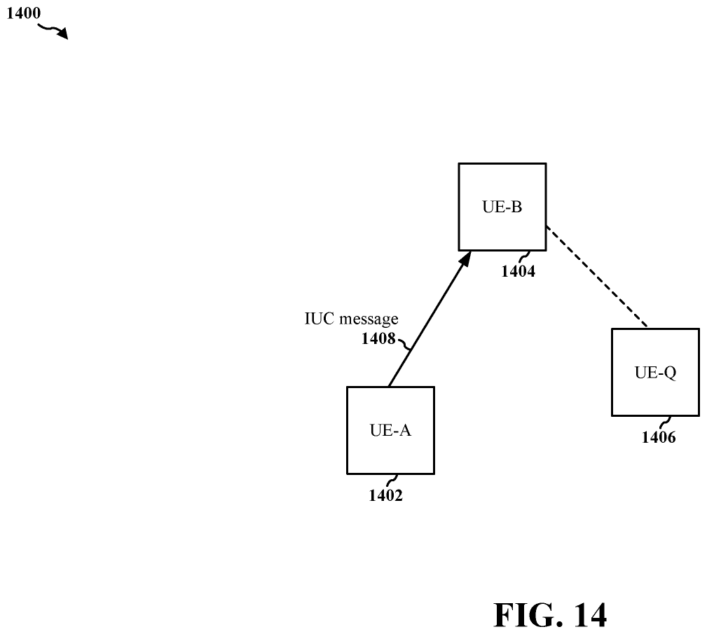

FIG. 14 illustrates an example of an IUC message. The diagram 1400 of FIG. 14 includes a UE-A 1402, a UE-B 1404, and a UE-Q 1406. The UE-Q 1406 may be a UE within the vicinity of at least one of UE-B or UE-A. The UE-A, in response to receiving a IUC request from UE-B or upon an occurrence of a condition that triggers an IUC message, may transmit an IUC information or message 1408 to UE-B. The IUC message 1408 may identify the transmitting UE (e.g., UE-Q 1406) for whom the IUC message 1408 applies. The IUC message may identify the UE (e.g., UE-A) that generated the IUC message 1408. The IUC message may indicate which resources UE-A prefers UE-Q to not use for the UE-Q transmission, instead of resources associated with a transmission for UE-B. UE-B may select or configure the resources for UE-Q's transmission based at least on the IUC message.

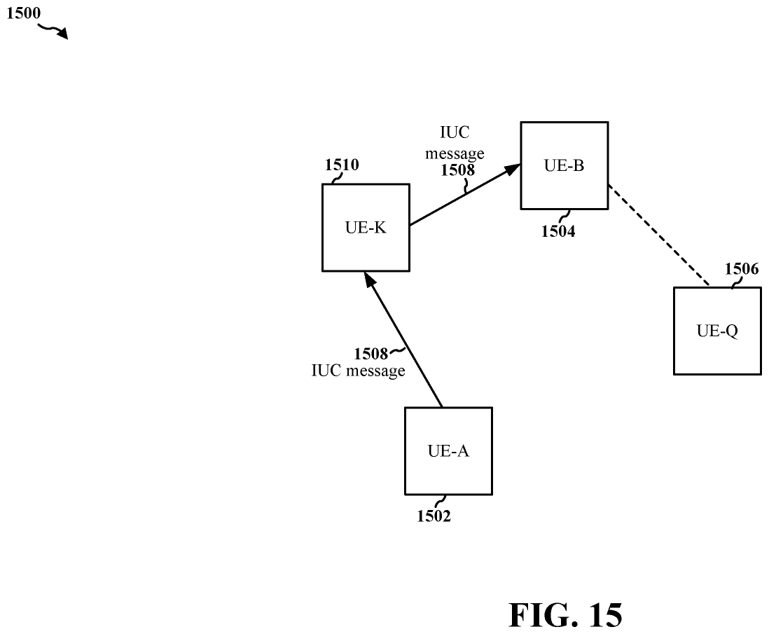

FIG. 15 illustrates an example of an IIoT application. The diagram 1500 of FIG. 15 includes a UE-A 1502, a UE-B 1504, a UE-Q 1506, and a UE-K 1510. In the example of FIG. 15, UE-A transmits the IUC message 1508 to UE-B. UE-K may receive and relay the IUC message from UE-A to UE-B. In some aspects, UE-K may or may not use the IUC message from UE-A for its own transmission resource selection. UE-B receives the IUC message which contains non-preferred resources for a transmission for UE-Q. UE-B may select or configure resources for UE-Q transmission, which may be based at least on the IUC message. In addition to existing fields in an IUC message, the IUC message may further comprise an originator UE (e.g., UE-A) of the IUC message, or a transmitter UE (e.g., UE-Q) that will be utilizing the non-preferred resources as determined by the originator UE. In some aspects, UE-B may comprise a PLC (e.g., PLC1 1104), UE-K may comprise a PLC (e.g., PLC2 1106), while UE-A may comprise an SA (e.g., SA3 1112), while UE-Q may comprise an SA (e.g., SA2 1110). UE-B (e.g., PLC1 1104) should avoid scheduling any transmission by UE-Q (e.g., SA2 1110) in UE-A's (e.g., SA3 1112) non-preferred resources for UE-Q's transmission.

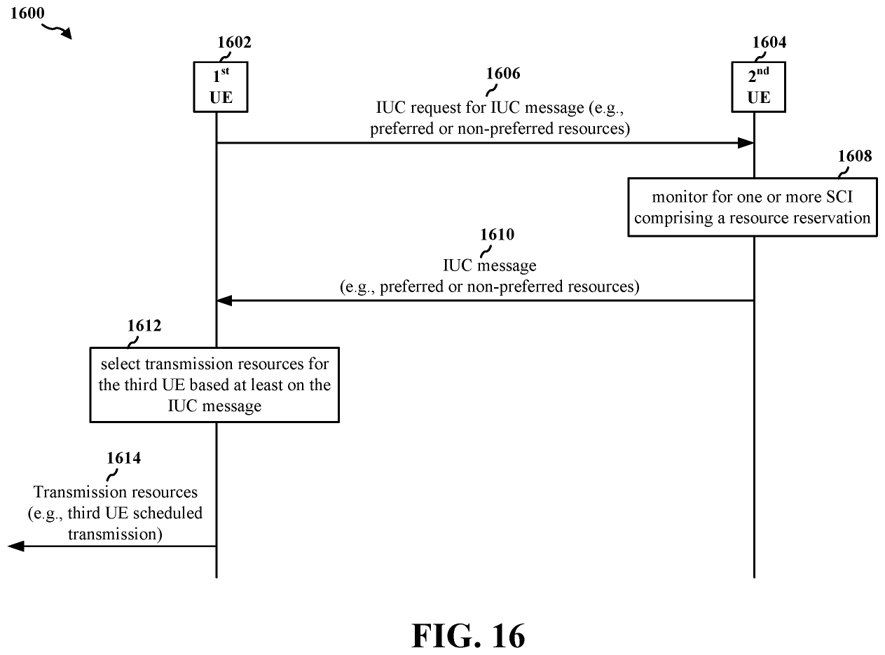

FIG. 16 is a call flow diagram 1600 of signaling between a first UE 1602 and a second UE 1604. The first UE 1602 or the second UE 1604 may be configured to communicate with a base station (not shown). For example, in the context of FIG. 1, the first UE 1602 may correspond to at least UE 104, the second UE 1604 may correspond to at least UE 104. In another example, in the context of FIG. 3, the UE 1604 may correspond to device 310 and the UE 1602 may correspond to device 350. At 1606, the first UE 1602 may transmit an IUC request for an IUC message. The first UE 1602 may transmit the IUC request for the IUC message to the second UE 1604. The second UE 1604 may receive the IUC request from the first UE 1602. The IUC message may indicate preferred resources or non-preferred resources for transmission of a signal by a third UE. In some aspects, the IUC request may comprise at least one of an identity of an originator of the IUC request, a target UE of the IUC request, or a transmitting UE for determination of the preferred resources or the non-preferred resources. In some aspects, the first UE may be the originator of the IUC request, the second UE may be the target UE, and the third UE may be the transmitting UE. Example aspects of the first UE transmitting an IUC request are described in connection with FIG. 7, 12, or 13.

At 1608, the second UE 1604 may monitor for one or more sidelink control information (SCI). The second UE 1604 may monitor for the one or more SCI comprising a resource reservation. The one or more SCI may be from one or more other UEs (not shown) within the vicinity of the second UE. In some aspects, the monitoring for the one or more SCI may occur during a sensing window. Example aspects of the second UE monitoring for one or more SCI are described in connection with FIG. 7, 8, 9, or 10.

At 1610, the second UE 1604 may transmit the IUC message. The second UE 1604 may transmit the IUC message to the first UE 1602. The first UE 1602 may receive the IUC message from the second UE 1604. The IUC message may indicate the preferred resources or the non-preferred resources for the transmission of the signal by the third UE. In some aspects, the IUC message may comprise the preferred resources for the transmission of the signal by the third UE. In some aspects, the IUC message may comprise the non-preferred resources for the transmission of the signal by the third UE. The IUC message may comprise at least one of a UE identity that is associated with the preferred resources or the non-preferred resources comprised within the IUC message or an identity of an origination UE that generated the IUC message. For example, in some aspects, the UE identity that is associated with the preferred resources or the non-preferred resources comprised within the IUC message is for the third UE. In some aspects, the second UE is the identity of the origination UE that generated the IUC message. Example aspects of the second UE transmitting the IUC message are described in connection with FIG. 7, 14, or 15.

At 1612, the first UE 1602 may select transmission resources for the third UE (not shown). The first UE 1602 may select transmission resources for transmission of the signal by the third UE based at least on the IUC message from the second UE 1604. The first UE may receive the IUC message from the second UE. The IUC message received from the second UE may indicate the preferred resources or the non-preferred resources for the transmission by the third UE. Example aspects of the first UE selecting transmission resources for the third UE are described in connection with FIG. 7, 8, 9, or 10.

At 1614, the first UE 1602 may provide the selected transmission resources to the third UE. The third UE may transmit a signal using the transmission resources selected by the first UE 1602 based at least one the IUC message.

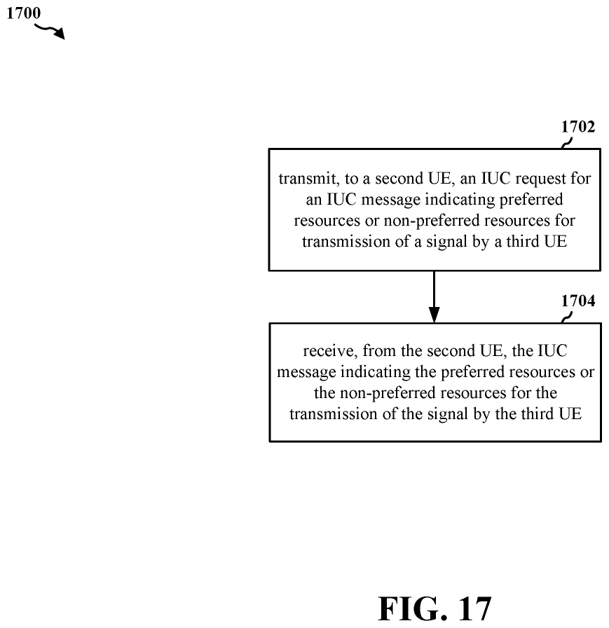

FIG. 17 is a flowchart 1700 of a method of wireless communication. The method may be performed by a first UE (e.g., the UE 104; the apparatus 1902). One or more of the illustrated operations may be omitted, transposed, or contemporaneous. The method may allow a first UE to request an IUC message from a second UE to schedule a transmission for a third UE.

At 1702, the first UE may transmit an IUC request for an IUC message. For example, 1702 may be performed by IUC component 198 of apparatus 1902. The first UE may transmit the IUC request for the IUC message to a second UE. The IUC message may indicate preferred resources or non-preferred resources for transmission of a signal by a third UE. In some aspects, the IUC request may comprise at least one of an identity of an originator of the IUC request, a target UE of the IUC request, or a transmitting UE for determination of the preferred resources or the non-preferred resources. In some aspects, the first UE may be the originator of the IUC request, the second UE may be the target UE, and the third UE may be the transmitting UE. Example aspects of transmitting an IUC request are described in connection with FIG. 7, 12, or 13.

At 1704, the first UE may receive the IUC message. For example, 1704 may be performed by IUC component 198 of apparatus 1902. The first UE may receive the IUC message from the second UE. The IUC message may indicate the preferred resources or the non-preferred resources for the transmission of the signal by the third UE. In some aspects, the IUC message may comprise the preferred resources for the transmission of the signal by the third UE. In some aspects, the IUC message may comprise the non-preferred resources for the transmission of the signal by the third UE. In some aspects, the IUC message may comprise at least one of a UE identity associated with the preferred resources or the non-preferred resources comprised within the IUC message or an identity of an origination UE that generated the IUC message. For example, in some aspects, the UE identity that is associated with the preferred resources or the non-preferred resources comprised within the IUC message is for the third UE. In another example, the second UE is the identity of the origination UE that generated the IUC message. Example aspects of receiving the IUC message are described in connection with FIG. 7, 14, or 15.

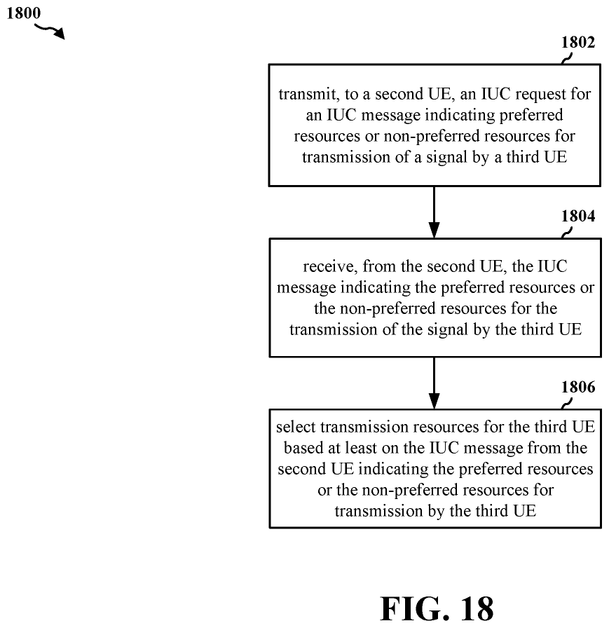

FIG. 18 is a flowchart 1800 of a method of wireless communication. The method may be performed by a UE (e.g., the UE 104; the apparatus 1902). One or more of the illustrated operations may be omitted, transposed, or contemporaneous. The method may allow a first UE to request an IUC message from a second UE to schedule a transmission for a third UE.

At 1802, the first UE may transmit an IUC request for an IUC message. For example, 1802 may be performed by IUC component 198 of apparatus 1902. The first UE may transmit the IUC request for the IUC message to a second UE. The IUC message may indicate preferred resources or non-preferred resources for transmission of a signal by a third UE. In some aspects, the IUC request may comprise at least one of an identity of an originator of the IUC request, a target UE of the IUC request, or a transmitting UE for determination of the preferred resources or the non-preferred resources. In some aspects, the first UE may be the originator of the IUC request, the second UE may be the target UE, and the third UE may be the transmitting UE. Example aspects of transmitting an IUC request are described in connection with FIG. 7, 12, or 13.

At 1804, the first UE may receive the IUC message. For example, 1804 may be performed by IUC component 198 of apparatus 1902. The first UE may receive the IUC message from the second UE. The IUC message may indicate the preferred resources or the non-preferred resources for the transmission of the signal by the third UE. In some aspects, the IUC message may comprise the preferred resources for the transmission of the signal by the third UE. In some aspects, the IUC message may comprise the non-preferred resources for the transmission of the signal by the third UE. In some aspects, the IUC message may comprise at least one of a UE identity associated with the preferred resources or the non-preferred resources comprised within the IUC message or an identity of an origination UE that generated the IUC message. For example, in some aspects, the UE identity that is associated with the preferred resources or the non-preferred resources comprised within the IUC message is for the third UE. In another example, the second UE is the identity of the origination UE that generated the IUC message. Example aspects of receiving the IUC message are described in connection with FIG. 7, 14, or 15.

At 1806, the first UE may select transmission resources for the third UE. For example, 1806 may be performed by IUC component 198 of apparatus 1902. The first UE may select transmission resources for transmission of the signal by the third UE based at least on the IUC message from the second UE. The first UE may receive the IUC message from the second UE. The IUC message received from the second UE may indicate the preferred resources or the non-preferred resources for the transmission by the third UE. Example aspects of selecting transmission resources for the third UE are described in connection with FIG. 7, 8, 9, or 10.

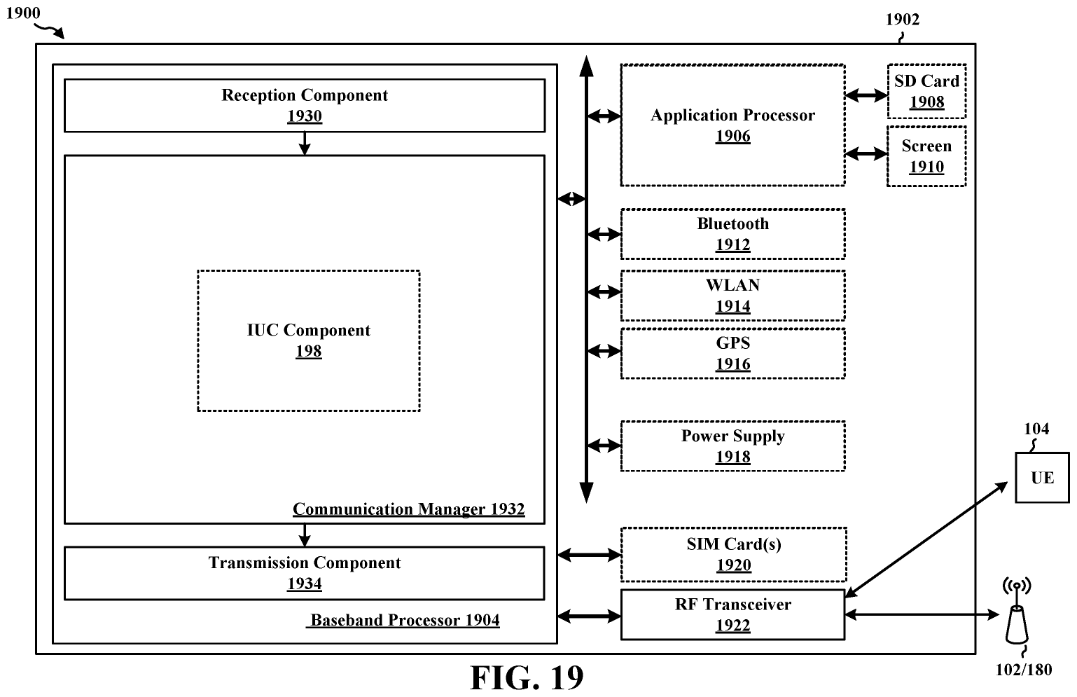

FIG. 19 is a diagram 1900 illustrating an example of a hardware implementation for an apparatus 1902. The apparatus 1902 may be a UE, a component of a UE, or may implement UE functionality. The apparatus 1902 may be an RSU, a component and an RSU, or may implement RSU functionality. The apparatus may be another device configured to transmit and/or receive sidelink communication. The apparatus 1902 includes a baseband processor 1904 (also referred to as a modem) coupled to a RF transceiver 1922. In some aspects, the baseband processor 1904 may be a cellular baseband processor and/or the RF transceiver 1922 may be a cellular RF transceiver. The apparatus 1902 may further include one or more subscriber identity modules (SIM) cards 1920, an application processor 1906 coupled to a secure digital (SD) card 1908 and a screen 1910, a Bluetooth module 1912, a wireless local area network (WLAN) module 1914, a Global Positioning System (GPS) module 1916, and/or a power supply 1918. The baseband processor 1904 communicates through the RF transceiver 1922 with the UE 104 and/or BS 102/180. The baseband processor 1904 may include a computer-readable medium/memory. The computer-readable medium/memory may be non-transitory. The baseband processor 1904 is responsible for general processing, including the execution of software stored on the computer-readable medium/memory. The software, when executed by the baseband processor 1904, causes the baseband processor 1904 to perform the various functions described in the present application. The computer-readable medium/memory may also be used for storing data that is manipulated by the baseband processor 1904 when executing software. The baseband processor 1904 further includes a reception component 1930, a communication manager 1932, and a transmission component 1934. The communication manager 1932 includes the one or more illustrated components. The components within the communication manager 1932 may be stored in the computer-readable medium/memory and/or configured as hardware within the baseband processor 1904. The baseband processor 1904 may be a component of the device 350 and may include the memory 360 and/or at least one of the TX processor 368, the RX processor 356, and the controller/processor 359. In one configuration, the apparatus 1902 may be a modem chip and include just the baseband processor 1904, and in another configuration, the apparatus 1902 may be the entire UE (e.g., see 350 of FIG. 3) and include the additional modules of the apparatus 1902.

The communication manager 1932 includes an IUC component 198 that is configured to transmit, to a second UE, an inter-UE coordination (IUC) request for an IUC message indicating preferred resources or non-preferred resources for transmission of a signal by a third UE; and receive, from the second UE, the IUC message indicating the preferred resources or the non-preferred resources for the transmission of the signal by the third UE. The IUC component 198 may be further configured to perform each of the blocks of the algorithm in the flowcharts of FIGS. 17 and 18, and/or the aspects performed by any of the UEs 704, 904, 1004, 1104, 1204, 1304, 1404, 1504, 1602<UE ref #s>.

The apparatus may include additional components that perform each of the blocks of the algorithm in the flowcharts of FIGS. 17 and 18, and/or the aspects performed by any of the UEs 704, 904, 1004, 1104, 1204, 1304, 1404, 1504, 1602. As such, each block in the flowcharts of FIGS. 17 and 18, and/or the aspects performed by any of the UEs 704, 904, 1004, 1104, 1204, 1304, 1404, 1504, 1602 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1902, and in particular the baseband processor 1904, may include means for transmitting, to a second UE, an inter-UE coordination (IUC) request for an IUC message indicating preferred resources or non-preferred resources for transmission of a signal by a third UE. The apparatus includes means for receiving, from the second UE, the IUC message indicating the preferred resources or the non-preferred resources for the transmission of the signal by the third UE. The apparatus further includes means for selecting transmission resources for the third UE based at least on the IUC message from the second UE indicating the preferred resources or the non-preferred resources for transmission by the third UE. The apparatus further includes means for selecting transmission resources for the transmission of the signal by the third UE based at least on the IUC message received from the second UE indicating the preferred resources or the non-preferred resources for transmission by the third UE. The apparatus may further include means configured to perform the algorithm in the flowcharts of any of FIGS. 17 and 18, and/or the aspects performed by any of the UEs 704, 904, 1004, 1104, 1204, 1304, 1404, 1504, 1602. The means may be one or more of the components of the apparatus 1902 configured to perform the functions recited by the means. As described herein, the apparatus 1902 may include the TX Processor 368, the RX Processor 356, and the controller/processor 359. As such, in one configuration, the means may be the TX Processor 368, the RX Processor 356, and the controller/processor 359 configured to perform the functions recited by the means.

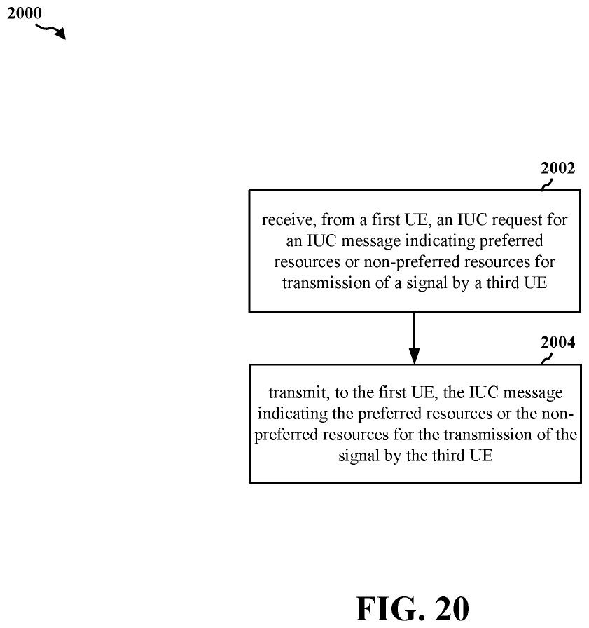

FIG. 20 is a flowchart 2000 of a method of wireless communication. The method may be performed by a second UE (e.g., the UE 104; the apparatus 2202). One or more of the illustrated operations may be omitted, transposed, or contemporaneous. The method may allow a second UE to transmit an IUC message to a first UE comprising available or non-available resources for transmission by a third UE.

At 2002, the second UE may receive an IUC request for an IUC message. For example, 2002 may be performed by IUC component 199 of apparatus 2202. The second UE may receive the IUC request from the first UE. The IUC message may indicate preferred resources or non-preferred resources for transmission of a signal by a third UE. In some aspects, the IUC request may comprise at least one of an identity of an originator of the IUC request, a target UE of the IUC request, or a transmitting UE for determination of the preferred resources or the non-preferred resources. For example, in some aspects, the first UE is the originator of the IUC request, the second UE is the target UE, and the third UE is the transmitting UE. Example aspects of the second UE receiving the IUC request are described in connection with FIG. 7, 12, or 13.

At 2004, the second UE may transmit the IUC message. For example, 2004 may be performed by IUC component 199 of apparatus 2202. The second UE may transmit the IUC message to the first UE. The IUC message may indicate the preferred resources or the non-preferred resources for the transmission of the signal by the third UE. In some aspects, the IUC message may comprise the preferred resources for the transmission of the signal by the third UE. In some aspects, the IUC message may comprise the non-preferred resources for the transmission of the signal by the third UE. The IUC message may comprise at least one of a UE identity associated with the preferred resources or the non-preferred resources comprised within the IUC message or an identity of an origination UE that generated the IUC message. For example, in some aspects, the UE identity that is associated with the preferred resources or the non-preferred resources comprised within the IUC message is for the third UE. In some aspects, the second UE is the identity of the origination UE that generated the IUC message. Example aspects of transmitting the IUC message are described in connection with FIG. 7, 14, or 15.

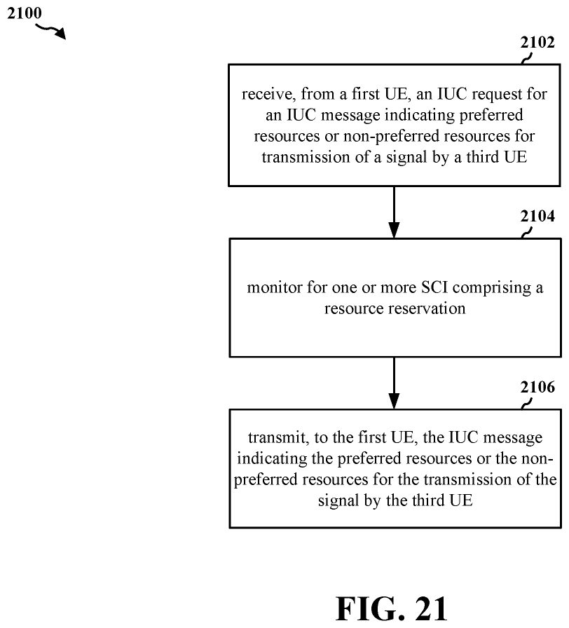

FIG. 21 is a flowchart 2100 of a method of wireless communication. The method may be performed by a UE (e.g., the UE 104; the apparatus 2202). One or more of the illustrated operations may be omitted, transposed, or contemporaneous. The method may allow a second UE to transmit an IUC message to a first UE comprising available or non-available resources for transmission by a third UE.

At 2102, the second UE may receive an IUC request for an IUC message. For example, 2102 may be performed by IUC component 199 of apparatus 2202. The second UE may receive the IUC request from the first UE. The IUC message may indicate preferred resources or non-preferred resources for transmission of a signal by a third UE. In some aspects, the IUC request may comprise at least one of an identity of an originator of the IUC request, a target UE of the IUC request, or a transmitting UE for determination of the preferred resources or the non-preferred resources. For example, in some aspects, the first UE is the originator of the IUC request, the second UE is the target UE, and the third UE is the transmitting UE. Example aspects of the second UE receiving the IUC request are described in connection with FIG. 7, 12, or 13.

At 2104, the second UE may monitor for one or more sidelink control information (SCI). For example, 2104 may be performed by IUC component 199 of apparatus 2202. The second UE may monitor for the one or more SCI comprising a resource reservation. The one or more SCI may be from one or more other UEs within the vicinity of the second UE. In some aspects, the monitoring for the one or more SCI may occur during a sensing window. Example aspects of monitoring for one or more SCI are described in connection with FIG. 7, 8, 9, or 10.

At 2106, the second UE may transmit the IUC message. For example, 2106 may be performed by IUC component 199 of apparatus 2202. The second UE may transmit the IUC message to the first UE. The IUC message may indicate the preferred resources or the non-preferred resources for the transmission of the signal by the third UE. In some aspects, the IUC message may comprise the preferred resources for the transmission of the signal by the third UE. In some aspects, the IUC message may comprise the non-preferred resources for the transmission of the signal by the third UE. The IUC message may comprise at least one of a UE identity associated with the preferred resources or the non-preferred resources comprised within the IUC message or an identity of an origination UE that generated the IUC message. For example, in some aspects, the UE identity that is associated with the preferred resources or the non-preferred resources comprised within the IUC message is for the third UE. In some aspects, the second UE is the identity of the origination UE that generated the IUC message. Example aspects of transmitting the IUC message are described in connection with FIG. 7, 14, or 15.

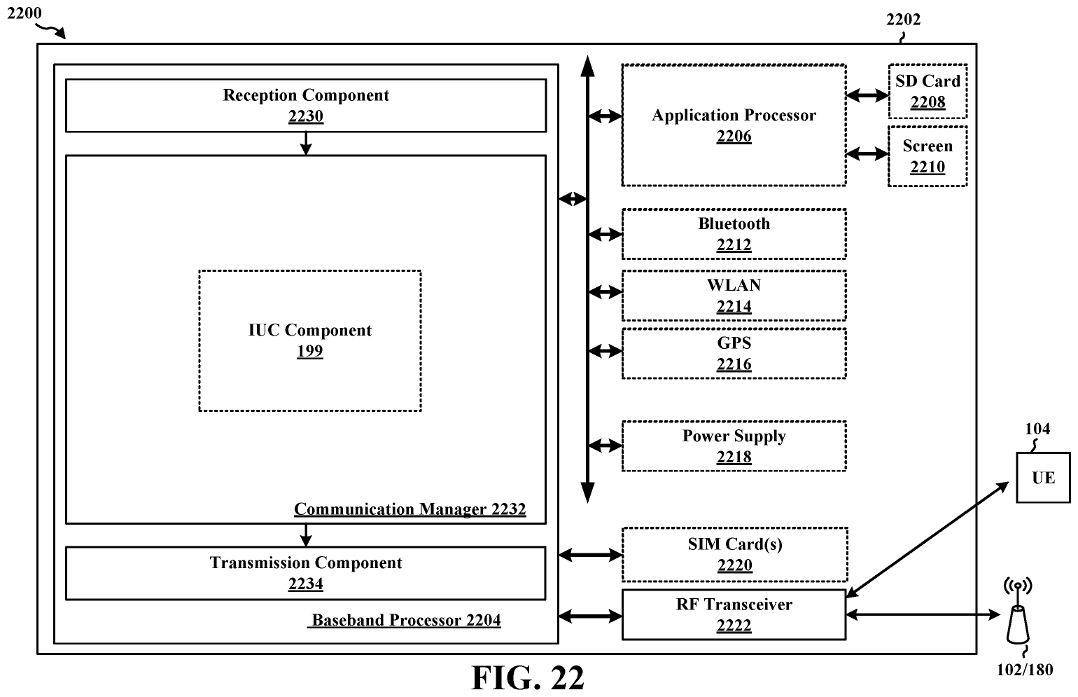

FIG. 22 is a diagram 2200 illustrating an example of a hardware implementation for an apparatus 2202. The apparatus 2202 may be a UE, a component of a UE, or may implement UE functionality. The apparatus 2202 may be an RSU, a component and an RSU, or may implement RSU functionality. The apparatus may be another device configured to transmit and/or receive sidelink communication. The apparatus 2202 includes a baseband processor 2204 (also referred to as a modem) coupled to a RF transceiver 2222. In some aspects, the baseband processor 2204 may be a cellular baseband processor and/or the RF transceiver 2222 may be a cellular RF transceiver. The apparatus 2202 may further include one or more subscriber identity modules (SIM) cards 2220, an application processor 2206 coupled to a secure digital (SD) card 2208 and a screen 2210, a Bluetooth module 2212, a wireless local area network (WLAN) module 2214, a Global Positioning System (GPS) module 2216, and/or a power supply 2218. The baseband processor 2204 communicates through the RF transceiver 2222 with the UE 104 and/or BS 102/180. The baseband processor 2204 may include a computer-readable medium/memory. The computer-readable medium/memory may be non-transitory. The baseband processor 2204 is responsible for general processing, including the execution of software stored on the computer-readable medium/memory. The software, when executed by the baseband processor 2204, causes the baseband processor 2204 to perform the various functions described in the present application. The computer-readable medium/memory may also be used for storing data that is manipulated by the baseband processor 2204 when executing software. The baseband processor 2204 further includes a reception component 2230, a communication manager 2232, and a transmission component 2234. The communication manager 2232 includes the one or more illustrated components. The components within the communication manager 2232 may be stored in the computer-readable medium/memory and/or configured as hardware within the baseband processor 2204. The baseband processor 2204 may be a component of the device 350 and may include the memory 360 and/or at least one of the TX processor 368, the RX processor 356, and the controller/processor 359. In one configuration, the apparatus 2202 may be a modem chip and include just the baseband processor 2204, and in another configuration, the apparatus 2202 may be the entire UE (e.g., see 350 of FIG. 3) and include the additional modules of the apparatus 2202.

The communication manager 2232 includes an IUC component 199 that is configured to receive, from a first UE, an IUC request for an IUC message indicating preferred resources or non-preferred resources for transmission of a signal by a third UE; and transmit, to the first UE, the IUC message indicating the preferred resources or the non-preferred resources for the transmission of the signal by the third UE. The IUC component 199 may be further configured to perform each of the blocks of the algorithm in the flowcharts of FIGS. 20 and 21, and/or the aspects performed by any of the UEs 702, 902, 1002, 1106, 1202, 1302, 1402, 1502, and 1604.

The apparatus may include additional components that perform each of the blocks of the algorithm in the flowcharts of FIGS. 20 and 21, and/or the aspects performed by any of the UEs 702, 902, 1002, 1106, 1202, 1302, 1402, 1502, and 1604. As such, each block in the flowcharts of FIGS. 20 and 21, and/or the aspects performed by any of the UEs 702, 902, 1002, 1106, 1202, 1302, 1402, 1502, and 1604 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2202, and in particular the baseband processor 2204, may include means for receiving, from a first UE, an inter-UE coordination (IUC) request for an IUC message indicating preferred resources or non-preferred resources for transmission of a signal by a third UE. The apparatus includes means for transmitting, to the first UE, the IUC message indicating the preferred resources or the non-preferred resources for the transmission of the signal by the third UE. The apparatus further includes means for monitoring for one or more sidelink control information (SCI) comprising a resource reservation. The apparatus may further include means configured to perform the algorithm in the flowcharts of any of FIGS. 20 and 21, and/or the aspects performed by any of the UEs 702, 902, 1002, 1106, 1202, 1302, 1402, 1502, and 1604. The means may be one or more of the components of the apparatus 2202 configured to perform the functions recited by the means. As described herein, the apparatus 2202 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

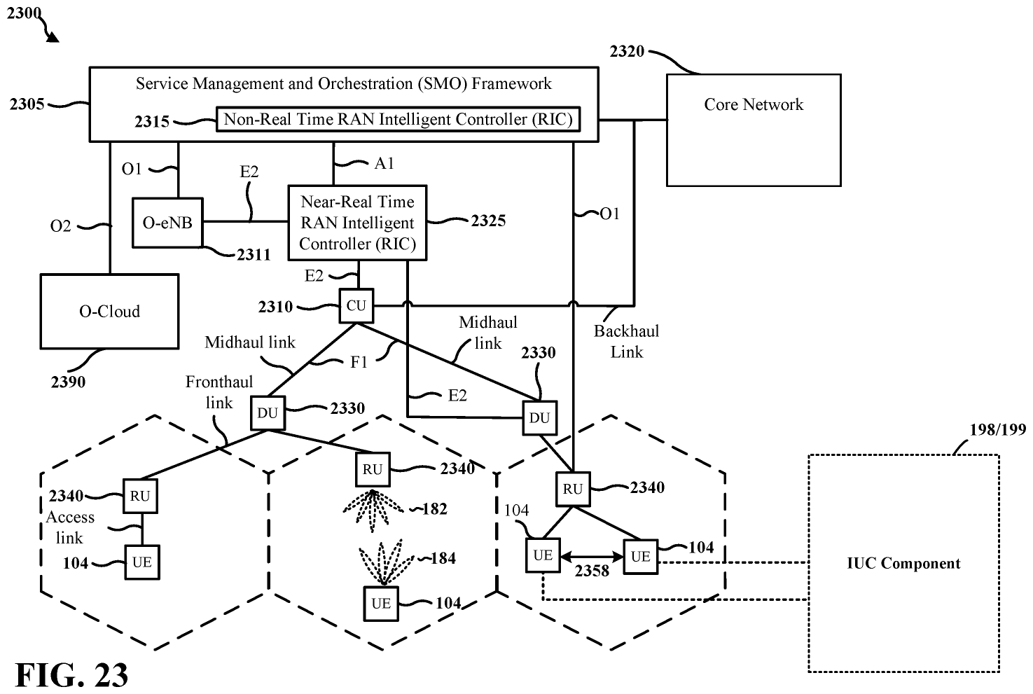

FIG. 23 shows a diagram illustrating an example disaggregated base station 2300 architecture. The disaggregated base station 2300 architecture may include one or more central units (CUs) 2310 that can communicate directly with a core network 2320 via a backhaul link, or indirectly with the core network 2320 through one or more disaggregated base station units (such as a Near-Real Time (Near-RT) RAN Intelligent Controller (RIC) 2325 via an E2 link, or a Non-Real Time (Non-RT) RIC 2315 associated with a Service Management and Orchestration (SMO) Framework 2305, or both). A CU 2310 may communicate with one or more distributed units (DUs) 2330 via respective midhaul links, such as an F1 interface. The DUs 2330 may communicate with one or more radio units (RUs) 2340 via respective fronthaul links. The RUs 2340 may communicate with respective UEs 104 via one or more radio frequency (RF) access links. In some implementations, the UE 104 may be simultaneously served by multiple RUs 2340.

Each of the units, i.e., the CUs 2310, the DUs 2330, the RUs 2340, as well as the Near-RT RICs 2325, the Non-RT RICs 2315 and the SMO Framework 2305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 2310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 2310. The CU 2310 may be configured to handle user plane functionality (i.e., Central Unit—User Plane (CU-UP)), control plane functionality (i.e., Central Unit—Control Plane (CU-CP)), or a combination thereof. In some implementations, the CU 2310 can be logically split into one or more CU-UP units and one or more CU-CP units. The CU-UP unit can communicate bidirectionally with the CU-CP unit via an interface, such as the E1 interface when implemented in an O-RAN configuration. The CU 2310 can be implemented to communicate with the DU 2330, as necessary, for network control and signaling.

The DU 2330 may correspond to a logical unit that includes one or more base station functions to control the operation of one or more RUs 2340. In some aspects, the DU 2330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3r d Generation Partnership Project (3GPP). In some aspects, the DU 2330 may further host one or more low PHY layers. Each layer (or module) can be implemented with an interface configured to communicate signals with other layers (and modules) hosted by the DU 2330, or with the control functions hosted by the CU 2310.

Lower-layer functionality can be implemented by one or more RUs 2340. In some deployments, an RU 2340, controlled by a DU 2330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 2340 can be implemented to handle over the air (OTA) communication with one or more UEs 104. In some implementations, real-time and non-real-time aspects of control and user plane communication with the RU(s) 2340 can be controlled by the corresponding DU 2330. In some scenarios, this configuration can enable the DU(s) 2330 and the CU 2310 to be implemented in a cloud-based RAN architecture, such as a vRAN architecture.

The SMO Framework 2305 may be configured to support RAN deployment and provisioning of non-virtualized and virtualized network elements. For non-virtualized network elements, the SMO Framework 2305 may be configured to support the deployment of dedicated physical resources for RAN coverage requirements which may be managed via an operations and maintenance interface (such as an O1 interface). For virtualized network elements, the SMO Framework 2305 may be configured to interact with a cloud computing platform (such as an open cloud (O-Cloud) 2390) to perform network element life cycle management (such as to instantiate virtualized network elements) via a cloud computing platform interface (such as an O2 interface). Such virtualized network elements can include, but are not limited to, CUs 2310, DUs 2330, RUs 2340 and Near-RT RICs 2325. In some implementations, the SMO Framework 2305 can communicate with a hardware aspect of a 4G RAN, such as an open eNB (O-eNB) 2311, via an O1 interface.

Additionally, in some implementations, the SMO Framework 2305 can communicate directly with one or more RUs 2340 via an O1 interface. The SMO Framework 2305 also may include a Non-RT RIC 2315 configured to support functionality of the SMO Framework 2305.

The Non-RT RIC 2315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 2325. The Non-RT RIC 2315 may be coupled to or communicate with (such as via an A1 interface) the Near-RT RIC 2325. The Near-RT RIC 2325 may be configured to include a logical function that enables near-real-time control and optimization of RAN elements and resources via data collection and actions over an interface (such as via an E2 interface) connecting one or more CUs 2310, one or more DUs 2330, or both, as well as an O-eNB, with the Near-RT RIC 2325.

In some implementations, to generate AI/ML models to be deployed in the Near-RT RIC 2325, the Non-RT RIC 2315 may receive parameters or external enrichment information from external servers. Such information may be utilized by the Near-RT RIC 2325 and may be received at the SMO Framework 2305 or the Non-RT RIC 2315 from non-network data sources or from network functions. In some examples, the Non-RT RIC 2315 or the Near-RT RIC 2325 may be configured to tune RAN behavior or performance. For example, the Non-RT RIC 2315 may monitor long-term trends and patterns for performance and employ AI/ML models to perform corrective actions through the SMO Framework 2305 (such as reconfiguration via O1) or via creation of RAN management policies (such as A1 policies).

FIG. 23 illustrates that some UEs 104 may communicate with each other directly using a D2D communication link 2358, such as sidelink.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof”include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof”may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following examples are illustrative only and may be combined with aspects of other embodiments or teachings described herein, without limitation.
Aspect 1 is a method of wireless communication at a first UE, comprising transmitting, to a second UE, an IUC request for an IUC message indicating preferred resources or non-preferred resources for transmission of a signal by a third UE; and receiving, from the second UE, the IUC message indicating the preferred resources or the non-preferred resources for the transmission of the signal by the third UE.
Aspect 2 is the method of aspect 1, further including selecting transmission resources for the third UE based at least on the IUC message from the second UE indicating the preferred resources or the non-preferred resources for transmission by the third UE.
Aspect 3 is the method of any of aspects 1 and 2, further includes that the IUC message comprises the preferred resources for the transmission of the signal by the third UE.
Aspect 4 is the method of any of aspects 1-3, further includes that the IUC message comprises the non-preferred resources for the transmission of the signal by the third UE.
Aspect 5 is the method of any of aspects 1-4, further includes that the IUC request comprises at least one of an identity of an originator of the IUC request, a target UE of the IUC request, or a transmitting UE for determination of the preferred resources or the non-preferred resources.
Aspect 6 is the method of any of aspects 1-5, further includes that the first UE is the originator of the IUC request, the second UE is the target UE, and the third UE is the transmitting UE.
Aspect 7 is the method of any of aspects 1-6, further includes that the IUC message comprises at least one of a UE identity associated with the preferred resources or the non-preferred resources comprised within the IUC message or an identity of an origination UE that generated the IUC message.
Aspect 8 is the method of any of aspects 1-7, further includes that the UE identity that is associated with the preferred resources or the non-preferred resources comprised within the IUC message is for the third UE.
Aspect 9 is the method of any of aspects 1-8, further includes that the second UE is the identity of the origination UE that generated the IUC message.
Aspect 10 is the method of any of aspects 1-9, further including selecting transmission resources for the transmission of the signal by the third UE based at least on the IUC message received from the second UE indicating the preferred resources or the non-preferred resources for transmission by the third UE.
Aspect 11 is an apparatus for wireless communication at a first UE including at least one processor coupled to a memory and at least one transceiver, the at least one processor configured to implement any of Aspects 1-10.
Aspect 12 is an apparatus for wireless communication at a first UE including means for implementing any of Aspects 1-10.
Aspect 13 is a computer-readable medium storing computer executable code, where the code when executed by a processor causes the processor to implement any of Aspects 1-10.
Aspect 14 is a method of wireless communication at a second UE, comprising receiving, from a first UE, an IUC request for an IUC message indicating preferred resources or non-preferred resources for transmission of a signal by a third UE; and transmitting, to the first UE, the IUC message indicating the preferred resources or the non-preferred resources for the transmission of the signal by the third UE.
Aspect 15 is the method of aspect 14, further including monitoring for one or more SCI comprising a resource reservation.
Aspect 16 is the method of any of aspects 14 and 15, further includes that monitoring for the one or more SCI occurs during a sensing window.
Aspect 17 is the method of any of aspects 14-16, further includes that the one or more SCI are from one or more UEs within a vicinity of the second UE.
Aspect 18 is the method of any of aspects 14-17, further includes that the IUC message comprises the preferred resources for the transmission of the signal by the third UE.
Aspect 19 is the method of any of aspects 14-18, further includes that the IUC message comprises the non-preferred resources for the transmission of the signal by the third UE.
Aspect 20 is the method of any of aspects 14-19, further includes that the IUC request comprises at least one of an identity of an originator of the IUC request, a target UE of the IUC request, or a transmitting UE for determination of the preferred resources or the non-preferred resources.
Aspect 21 is the method of any of aspects 14-20, further includes that the first UE is the originator of the IUC request, the second UE is the target UE, and the third UE is the transmitting UE.
Aspect 22 is the method of any of aspects 14-21, further includes that the IUC message comprises at least one of a UE identity that is associated with the preferred resources or the non-preferred resources comprised within the IUC message or an identity of an origination UE that generated the IUC message.

Aspect 23 is the method of any of aspects 14-22, further includes that the UE identity that is associated with the preferred resources or the non-preferred resources comprised within the IUC message is for the third UE.
Aspect 24 is the method of any of aspects 14-23, further includes that the second UE is the identity of the origination UE that generated the IUC message.
Aspect 25 is an apparatus for wireless communication at a second UE including at least one processor coupled to a memory and at least one transceiver, the at least one processor configured to implement any of Aspects 14-24.
Aspect 26 is an apparatus for wireless communication at a second UE including means for implementing any of Aspects 14-24.
Aspect 27 is a computer-readable medium storing computer executable code, where the code when executed by a processor causes the processor to implement any of Aspects 14-24.

What is claimed is:

1. An apparatus for wireless communication at a first user equipment (UE), comprising:
a memory; and
at least one processor coupled to the memory and, based at least in part on information stored in the memory, the at least one processor is configured to:
transmit, to a second UE, an inter-UE coordination (IUC) request for an IUC message indicating preferred resources or non-preferred resources for transmission of a signal by a third UE; and
receive, from the second UE, the IUC message indicating the preferred resources or the non-preferred resources for the transmission of the signal by the third UE.

2. The apparatus of claim 1, further comprising a transceiver coupled to the at least one processor.

3. The apparatus of claim 1, wherein the at least one processor is configured to:
select transmission resources for the third UE based at least on the IUC message from the second UE indicating the preferred resources or the non-preferred resources for transmission by the third UE.

4. The apparatus of claim 1, wherein the IUC message comprises the preferred resources for the transmission of the signal by the third UE.

5. The apparatus of claim 1, wherein the IUC message comprises the non-preferred resources for the transmission of the signal by the third UE.

6. The apparatus of claim 1, wherein the IUC request comprises at least one of an identity of an originator of the IUC request, a target UE of the IUC request, or a transmitting UE for determination of the preferred resources or the non-preferred resources.

7. The apparatus of claim 6, wherein the first UE is the originator of the IUC request, the second UE is the target UE, and the third UE is the transmitting UE.

8. The apparatus of claim 1, wherein the IUC message comprises at least one of a UE identity associated with the preferred resources or the non-preferred resources comprised within the IUC message or an identity of an origination UE that generated the IUC message.

9. The apparatus of claim 8, wherein the UE identity that is associated with the preferred resources or the non-preferred resources comprised within the IUC message is for the third UE.

10. The apparatus of claim 8, wherein the second UE is the identity of the origination UE that generated the IUC message.

11. The apparatus of claim 8, wherein the at least one processor is configured to:
select transmission resources for the transmission of the signal by the third UE based at least on the IUC message received from the second UE indicating the preferred resources or the non-preferred resources for transmission by the third UE.

12. A method of wireless communication at a first user equipment (UE), comprising:
transmitting, to a second UE, an inter-UE coordination (IUC) request for an IUC message indicating preferred resources or non-preferred resources for transmission of a signal by a third UE; and
receiving, from the second UE, the IUC message indicating the preferred resources or the non-preferred resources for the transmission of the signal by the third UE.

13. The method of claim 12, further comprising:
selecting transmission resources for the third UE based at least on the IUC message from the second UE indicating the preferred resources or the non-preferred resources for transmission by the third UE.

14. The method of claim 12, wherein the IUC message comprises at least one of a UE identity that is associated with the preferred resources or the non-preferred resources comprised within the IUC message or an identity of an origination UE that generated the IUC message.

15. The method of claim 14, further comprising:
selecting transmission resources for the transmission of the signal by the third UE based at least on the IUC message received from the second UE indicating the preferred resources or the non-preferred resources for transmission by the third UE.

16. An apparatus for wireless communication at a second user equipment (UE), comprising:
a memory; and
at least one processor coupled to the memory and, based at least in part on information stored in the memory, the at least one processor is configured to:
receive, from a first UE, an inter-UE coordination (IUC) request for an IUC message indicating preferred resources or non-preferred resources for transmission of a signal by a third UE; and
transmit, to the first UE, the IUC message indicating the preferred resources or the non-preferred resources for the transmission of the signal by the third UE.

17. The apparatus of claim 16, further comprising a transceiver coupled to the at least one processor.

18. The apparatus of claim 16, wherein the at least one processor is configured to:
monitor for one or more sidelink control information (SCI) comprising a resource reservation.

19. The apparatus of claim 18, wherein monitoring for the one or more SCI occurs during a sensing window.

20. The apparatus of claim 18, wherein the one or more SCI are from one or more UEs within a vicinity of the second UE.

21. The apparatus of claim 16, wherein the IUC message comprises the preferred resources for the transmission of the signal by the third UE.

22. The apparatus of claim 16, wherein the IUC message comprises the non-preferred resources for the transmission of the signal by the third UE.

23. The apparatus of claim 16, wherein the IUC request comprises at least one of an identity of an originator of the IUC request, a target UE of the IUC request, or a transmitting UE for determination of the preferred resources or the non-preferred resources.

24. The apparatus of claim 23, wherein the first UE is the originator of the IUC request, the second UE is the target UE, and the third UE is the transmitting UE.

25. The apparatus of claim 16, wherein the IUC message comprises at least one of a UE identity that is associated with the preferred resources or the non-preferred resources comprised within the IUC message or an identity of an origination UE that generated the IUC message.

26. The apparatus of claim 25, wherein the UE identity that is associated with the preferred resources or the non-preferred resources comprised within the IUC message is for the third UE.

27. The apparatus of claim 25, wherein the second UE is the identity of the origination UE that generated the IUC message.

28. A method of wireless communication at a second user equipment (UE), comprising:
receiving, from a first UE, an inter-UE coordination (IUC) request for an IUC message indicating preferred resources or non-preferred resources for transmission of a signal by a third UE; and
transmitting, to the first UE, the IUC message indicating the preferred resources or the non-preferred resources for the transmission of the signal by the third UE.

29. The method of claim 28, further comprising:
monitoring for one or more sidelink control information (SCI) comprising a resource reservation.

30. The method of claim 28, wherein the IUC request comprises at least one of an identity of an originator of the IUC request, a target UE of the IUC request, or a transmitting UE for determination of the preferred resources or the non-preferred resources.
